(19) United States
(12) Patent Application Publication
(10) Pub. No.: US 2022/0277882 A1
(43) Pub. Date: Sep. 1, 2022

(54) CORE COOLING STRUCTURE AND POWER CONVERSION DEVICE INCLUDING THE SAME

(71) Applicant: Mitsubishi Electric Corporation, Chiyoda-ku, Tokyo (JP)

(72) Inventors: Yoshikazu TSUNODA, Chiyoda-ku, Tokyo (JP); Takashi KUMAGAI, Chiyoda-ku, Tokyo (JP); Kenta FUJII, Chiyoda-ku, Tokyo (JP); Tomohito FUKUDA, Chiyoda-ku, Tokyo (JP)

(73) Assignee: Mitsubishi Electric Corporation, Chiyoda-ku, Tokyo (JP)

(21) Appl. No.: 17/626,136

(22) PCT Filed: Jul. 22, 2020
(86) PCT No.: PCT/JP2020/028424

§ 371 Date: Jan. 11, 2022

(30) Foreign Application Priority Data
Aug. 22, 2019 (JP) 2019-151844

(51) Int. Cl. H01F 27/08; H01F 27/26; H01F 27/06

(52) U.S. Cl. CPC H01F 27/085; H01F 27/266; H01F 27/06; H01F 2027/065

(57) ABSTRACT

A core cooling structure includes a core and a housing. The core includes an upper core and a lower core. The core is attached to the housing. The upper core includes a heat dissipation fin that extends along a magnetic path and is disposed at an interval in a direction intersecting the magnetic path. The lower core is attached so as to be fitted into the housing.

### TECHNICAL FIELD

The present disclosure relates to a core cooling structure having a function of cooling a core as a magnetic circuit component, and a power conversion device including the core cooling structure.

### BACKGROUND ART

Power electronic devices such as a power conversion device or an electric and electronic device are required to be downsized. Electric and electronic components such as a power semiconductor element mounted on the power electronic device or a semiconductor element mounted on the electric and electronic devices have been downsized due to improvement of a cooling technique. On the other hand, magnetic circuit component such as a transformer or a reactor is one of electric and electronic components that are difficult to cool and are not yet downsized.

Heat generation from the magnetic circuit component includes heat generation due to an iron loss and heat generation due to a copper loss. The iron loss is a loss generated in a core, and is referred to as a core loss. The copper loss is a loss generated in wiring (winding) wound around the core.

Recently, a shape of the winding has been changed for the heat generation due to the copper loss. That is, measures have been taken to reduce the loss by changing a sectional shape of the winding from a circular shape to a rectangular shape to increase a sectional area. Furthermore, a cooling capacity of the core is improved by improving a heat dissipation structure of the winding or the like, and measures against the heat generation have been taken for downsizing of the core.

However, there are few proposals that actively reduce the core loss and contribute to downsizing of the core. For example, PTL 1 proposes a structure in which irregularities are formed on an outer peripheral surface of a rectangular core. PTL 2 proposes a structure in which a reactor is embedded in a heat sink having a heat dissipation fin.

### CITATION LIST

### Patent Literature

PTL 1: Japanese Patent Laying-Open No. 2006-19418
PTL 2: Japanese Patent Laying-Open No. 2013-172096

### Non Patent Literature

NPL 1: https://www.tokin.com/product/pdf_dl/f_core.pdf

### SUMMARY OF INVENTION

### Technical Problem

The core used in the transformer, the reactor, and the like is required to be more efficiently cooled to improve the heat dissipation. The present disclosure has been made under such development, and one object of the present disclosure is to provide a core cooling structure in which the heat dissipation is effectively performed, and another object of the present disclosure is to provide a power conversion device to which the core cooling structure is applied.

### Solution to Problem

According to one aspect of the present disclosure, a core cooling structure is a core cooling structure applied to a core as a component of a magnetic circuit, and includes a core and a housing. The core includes a first core unit and a second core unit, and a magnetic path is formed by the first core unit and the second core unit that are disposed to face each other. The core is attached to the housing. At least one first heat dissipation fin extending in one direction along the magnetic path is formed in the first core unit. The second core unit is attached so as to be fitted in the housing. The housing includes a heat dissipation unit that releases heat.

According to another aspect of the present disclosure, another core cooling structure is a core cooling structure applied to a core as a component of a magnetic circuit, and includes a core and a housing. The core includes a first core unit and a second core unit, and a magnetic path is formed by the first core unit and the second core unit that are disposed to face each other. The core is attached to the housing. The housing includes a housing first unit and a housing second unit. A second core unit is attached to the housing first unit. A first core unit is attached to the housing second unit. The housing first unit and the housing second unit are disposed so as to face each other with the core sandwiched therebetween. The first core unit is attached so as to be fitted in the housing second unit. The second core unit is attached so as to be fitted in the housing first unit. The housing first unit includes a first heat dissipation unit that releases heat. The housing second unit includes a second heat dissipation unit that releases heat.

According to still another aspect of the present disclosure, a power conversion device is a power conversion device including the above-described core cooling structure, and includes a printed circuit board, a switching element, and a diode. A core is mounted on the printed circuit board. The switching element and the diode element are disposed between the printed circuit board and a housing. A first core unit and a second core unit of the core are disposed so as to face each other with the printed circuit board interposed therebetween through a through-hole made in the printed circuit board. The first core unit is disposed on a side of one main surface of the printed circuit board. The housing and the second core unit are disposed on a side of the other main surface of the printed circuit board.

### Advantageous Effects of Invention

According to the core cooling structure of the present disclosure, the core includes the first core unit and the second core unit, the first core unit includes the first heat dissipation fin, and the second core unit is attached so as to be fitted in the housing including the heat dissipation unit that releases the heat. Thus, the heat of the core is efficiently dissipated, and the core can be cooled.

According to another core cooling structure of the present disclosure, the core includes the first core unit and the second core unit. The first core unit is attached to the housing first unit including the first heat dissipation unit that releases the heat. The second core unit is attached to the housing second unit including the second heat dissipation unit that releases the heat. Thus, the heat of the core is efficiently dissipated, and the core can be cooled.

According to the power conversion device of the present disclosure, because the above-described core cooling structure is provided, the core of the power conversion device can be efficiently cooled.

### BRIEF DESCRIPTION OF DRAWINGS

FIG. 1 is a perspective view illustrating an example of a core cooling structure according to a first embodiment of the present disclosure.

FIG. 2 is a sectional view taken along a line II-II in FIG. 1 in the first embodiment.

FIG. 3 is an exploded perspective view illustrating a core cooling structure of the first embodiment.

FIG. 4 is a sectional view taken along a line IV-IV in FIG. 2 in the first embodiment.

FIG. 5 is an exploded perspective view illustrating a core structure in which a fin is formed in the first embodiment.

FIG. 6 is a partially enlarged sectional view illustrating the fin in the core in the first embodiment.

FIG. 7 is a first graph illustrating a relationship between a core loss and a temperature in the first embodiment.

FIG. 8 is a second graph illustrating the relationship between the core loss and the temperature in the first embodiment.

FIG. 9 is a circuit diagram related to a DC to DC converter as a first example of a power conversion device in the first embodiment.

FIG. 10 is a plan view schematically illustrating a structure of the first example of the power conversion device to which the core cooling structure is applied in the first embodiment.

FIG. 11 is a sectional view taken along a line XI-XI in FIG. 10 in the first exemplary embodiment.

FIG. 12 is an exploded perspective view illustrating the structure of the power conversion device in the first embodiment.

FIG. 13 is a plan view schematically illustrating a structure of a second example of the power conversion device in the first embodiment.

FIG. 14 is a sectional view illustrating a structure of a third example of the power conversion device in the first embodiment.

FIG. 15 is a sectional view illustrating a structure of a fourth example of the power conversion device in the first embodiment.

FIG. 16 is a sectional view illustrating a structure of a first example of a power conversion device according to a second embodiment of the present disclosure.

FIG. 17 is an exploded perspective view illustrating an example of a structure of a core of the power conversion device in the second embodiment.

FIG. 18 is an exploded perspective view illustrating a structure of a first example of the power conversion device in the second embodiment.

FIG. 19 is a sectional view illustrating a structure of a second example of the power conversion device in the second embodiment.

FIG. 20 is a sectional view illustrating a structure of a first example of a power conversion device according to a third embodiment of the present disclosure.

FIG. 21 is a sectional view taken along a line XXI-XXI in FIG. 20 in the third embodiment.

FIG. 22 is an exploded perspective view illustrating an example of a structure of a core in the third embodiment.

FIG. 23 is a sectional view taken along a line XXIII-XXIII in FIG. 20 in the third embodiment.

FIG. 24 is an exploded perspective view illustrating another example of the structure of the core in the third embodiment.

FIG. 25 is a sectional view illustrating a structure of a second example of the power conversion device in the third embodiment.

FIG. 26 is a sectional view taken along a line XXVI-XXVI in FIG. 25 in the third embodiment.

FIG. 27 is a sectional view taken along a line XXVII-XXVII in FIG. 25 in the third embodiment.

FIG. 28 is a sectional view illustrating a structure of a first example of a power conversion device according to a fourth embodiment of the present disclosure.

FIG. 29 is an exploded perspective view illustrating an example of a structure of a core of the power conversion device in the fourth embodiment.

FIG. 30 is an exploded perspective view illustrating another example of the structure of the core of the power conversion device in the fourth embodiment.

FIG. 31 is a plan view schematically illustrating a structure of a second example of the power conversion device in the fourth embodiment.

FIG. 32 is a sectional view taken along a line XXXII-XXXII in FIG. 31 in the fourth embodiment.

FIG. 33 is a sectional view illustrating a structure of a first example of a power conversion device according to a fifth embodiment of the present disclosure.

FIG. 34 is an exploded perspective view illustrating an example of a structure of a core of the power conversion device in the fifth embodiment.

FIG. 35 is an exploded perspective view illustrating another example of the structure of the core of the power conversion device in the fifth embodiment.

FIG. 36 is a sectional view illustrating a structure of a second example of the power conversion device in the fifth embodiment.

FIG. 37 is a sectional view illustrating a structure of a first example of a power conversion device according to a sixth embodiment of the present disclosure.

FIG. 38 is a sectional view illustrating a structure of a second example of the power conversion device in the sixth embodiment.

FIG. 39 is a sectional view illustrating a structure of a third example of the power conversion device in the sixth embodiment.

FIG. 40 is a sectional view illustrating a structure of a fourth example of the power conversion device in the sixth embodiment.

FIG. 41 is a sectional view illustrating a structure of a fifth example of the power conversion device in the sixth embodiment.

FIG. 42 is a sectional view illustrating a structure of a sixth example of the power conversion device in the sixth embodiment.

FIG. 43 is a sectional view illustrating a structure of a seventh example of the power conversion device in the sixth embodiment.

FIG. 44 is a sectional view illustrating a structure of an eighth example of the power conversion device in the sixth embodiment.

FIG. 45 is a sectional view illustrating a structure of a ninth example of the power conversion device in the sixth embodiment.

FIG. 46 is a sectional view illustrating a structure of a tenth example of the power conversion device in the sixth embodiment.

FIG. 47 is a sectional view illustrating a structure of a first example of a power conversion device according to a seventh embodiment of the present disclosure.

FIG. 48 is a sectional view illustrating a structure of a second example of the power conversion device in the seventh embodiment.

FIG. 49 is a sectional view illustrating a structure of a third example of the power conversion device in the seventh embodiment.

FIG. 50 is a sectional view illustrating a structure of a fourth example of the power conversion device in the seventh embodiment.

FIG. 51 is an exploded perspective view illustrating a structure of a power conversion device according to an eighth embodiment of the present disclosure.

FIG. 52 is a perspective view illustrating an example of a method for manufacturing an upper core in the eighth embodiment.

FIG. 53 is a perspective view illustrating an example of a method for manufacturing a lower core in the eighth embodiment.

FIG. 54 is a perspective view illustrating another example of the method for manufacturing the upper core in the eighth embodiment.

FIG. 55 is a perspective view illustrating another example of the method for manufacturing the lower core in the eighth embodiment.

FIG. 56 is a perspective view illustrating a structure of another upper core in the eighth embodiment.

FIG. 57 is a side view schematically illustrating a structure of a traveling device to which a power electronic device equipped with the power conversion device of the seventh embodiment is attached as an example of the power conversion device according to each embodiment.

### DESCRIPTION OF EMBODIMENTS

### First Embodiment

(Core Cooling Structure)

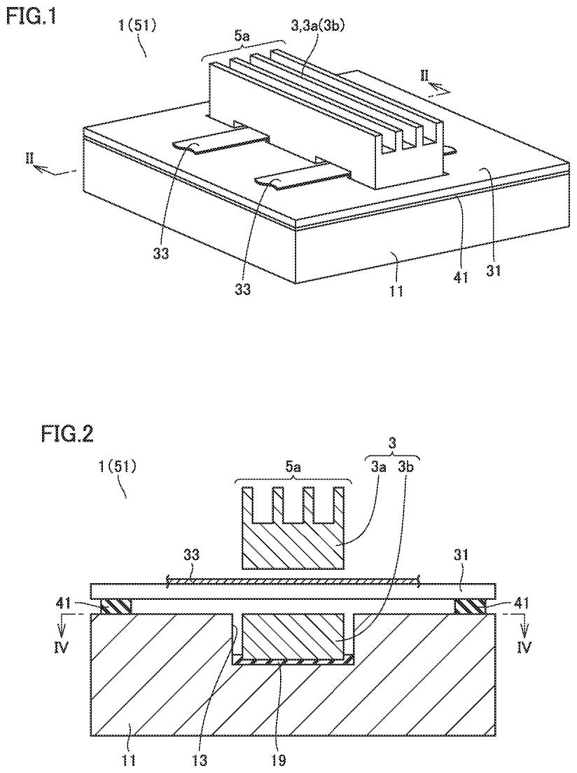

An example of a core cooling structure according to a first embodiment will be described. As illustrated in FIGS. 1 and 2, a core cooling structure 1 includes a core 3 and a housing 11. Core 3 is attached to housing 11. Core 3 includes an upper core 3a as a first core unit and a lower core 3b as a second core unit. Core 3 is mounted on a printed circuit board 31. In this specification, a state in which core 3 is mounted on printed circuit board 31 includes a state in which printed circuit board 31 is assembled to housing 11 in a state in which core 3 is attached to housing 11.

Printed circuit board 31 is disposed on housing 11 with a strut 41 interposed therebetween. For example, an insulating resin spacer or a conductive metal spacer can be applied as strut 41. A recess 13 is formed in housing 11. Lower core 3b is fitted in recess 13 with a thermal interface material (TIM) 19 interposed therebetween.

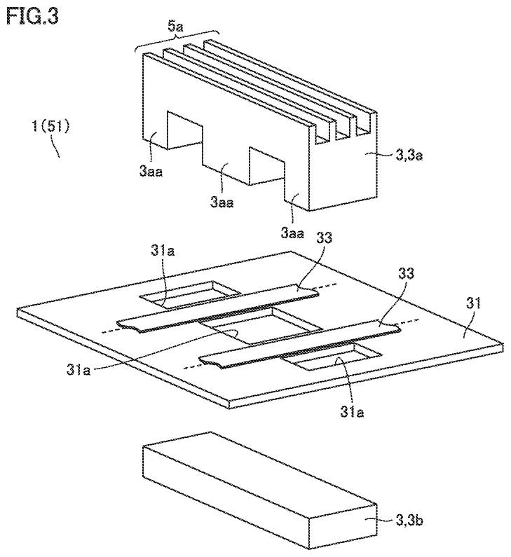

As illustrated in FIG. 3, for example, upper core 3a is an E-type having a shape of an alphabet “E”. E-shaped upper core 3a has three legs 3aa. For example, lower core 3b is an I-type having a shape of an alphabet “I”. A through-hole 31a corresponding to leg 3aa is made in printed circuit board 31.

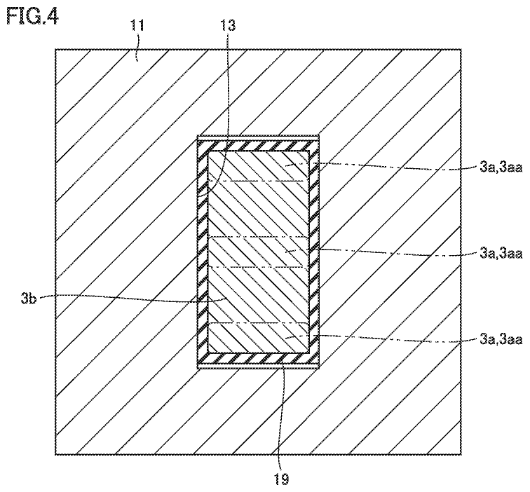

Upper core 3a and lower core 3b are disposed so as to face each other in such a manner that leg 3aa is inserted into through-hole 31a to sandwich printed circuit board 31 between upper core 3a and lower core 3b. A wiring pattern 33 wound around core 3 is formed on printed circuit board 31. As illustrated in FIG. 4, in the state in which core 3 is mounted on printed circuit board 31, leg 3aa of upper core 3a comes into contact with lower core 3b.

As illustrated in FIG. 5, a fin 5a extending in one direction as a first heat dissipation fin is formed in upper core 3a. A plurality of fins 5a are formed at intervals in another direction intersecting one direction. When current flows through wiring pattern 33, a closed magnetic path (see an arrow) is formed in core 3. The magnetic path is formed along fin 5a extending in one direction, and does not intersect fin 5a. That is, at least one fin 5a extending in one direction along the magnetic path is formed in upper core 3a.

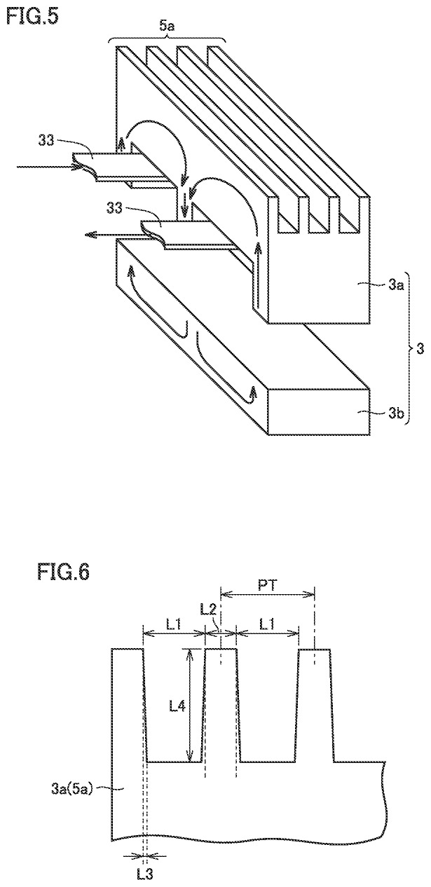

As illustrated in FIG. 6, an interval L1 between fins 5a is set to, for example, greater than or equal to 2 mm in a widest portion in order to take in cooling air. A thickness L2 of fin 5a is set to, for example, greater than or equal to 1.4 mm in a narrowest portion in order to secure strength of core 3. From such a dimensional relationship, a pitch PT of fins 5a is desirably set to, for example, greater than or equal to 2.7 mm.

For example, a height L4 of fin 5a is set to greater than or equal to 1.5 mm. In consideration of ease of taking out fin 5a from a molding die when fin 5a is primarily molded by the molding die, a draft angle at which a length L3 is greater than or equal to 0.1 mm is set with respect to height L4 of fin 5a. That is, fin 5a is not formed separately from upper core 3a, but is integrally formed of the same material.

In core 3, as the width (L1−2×L3) of the bottom portion located between fin 5a and fin 5a is larger, an effective sectional area as core 3 can be secured, and the draft angle can be secured. However, a surface area of core 3 including fin 5a is limited when a width of the bottom portion is increased. For this reason, core 3 is required to be designed in consideration of trade-off between the effective sectional area of fin 5a and the surface area of core 3. The basic structure of core cooling structure 1 is configured as described above.

In core cooling structure 1, core 3 includes upper core 3a and lower core 3b. Upper core 3a includes integrally-formed fin 5a. Lower core 3b is attached to recess 13 of housing 11. Thus, core 3 can be efficiently cooled. As will be described later, for example, the heat dissipation effect can be improved by providing a water cooling device or the like in housing 11. In addition, quantitative heat dissipation design can be performed based on thermal conductivity of the core 3, the thermal conductivity of TIM 19, and the thermal conductivity of housing 11 and the like.

Furthermore, fin 5a is formed so as to extend in the forward direction along the magnetic path. That is, fin 5a is formed in the forward direction with respect to the magnetic flux. As a result, fin 5a can also secure a sectional area as the core in which the magnetic path is formed, and for example, a stable characteristic can be obtained as the transformer or the reactor.

In addition, because lower core 3b is fitted into recess 13 of housing 11, the core is efficiently cooled, and the size of core 3 is not required to be increased for cooling, which can contribute to the downsizing of the core. Furthermore, because fin 5a is also a portion of the sectional area of core 3 in which the magnetic path is formed, the height of upper core 3a can be reduced, which contributes to the downsizing of core 3.

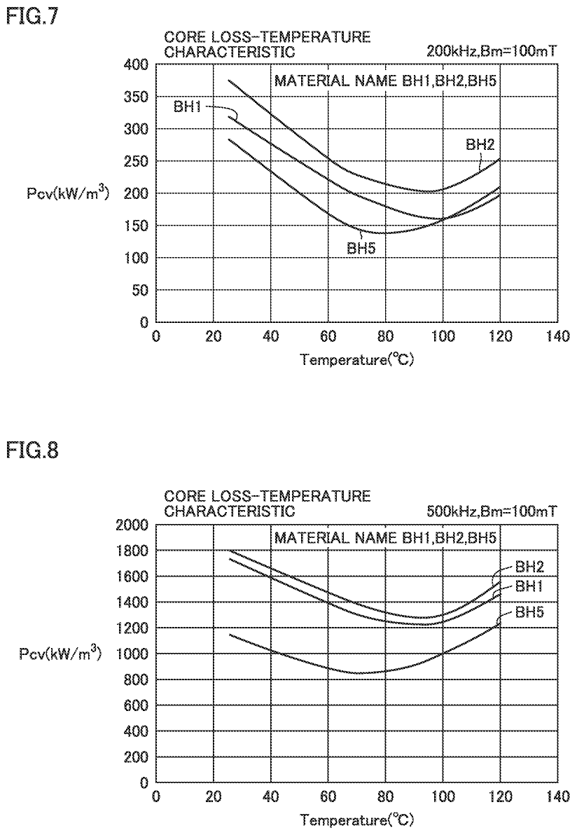

In this way, in core cooling structure 1, core 3 is efficiently cooled to suppress a temperature change, and the stable characteristic can be obtained as the transformer or the reactor. At this point, an effect of obtaining the stable core characteristic (transformer characteristic) by suppressing the temperature change will be described using a graph of a temperature characteristic of a core loss described in NPL 1. Each of FIGS. 7 and 8 illustrates the relationship between the temperature and the core loss. A horizontal axis represents temperature (° C.). A vertical axis represents the core loss (kW/m³) and represents the core loss per unit volume.

FIG. 7 is a graph illustrating the relationship between the core loss and the temperature when magnetic flux density Bm of a magnetic field is 100 mT and a frequency is 200 kHz for each of core materials BH1, BH2, BH5. FIG. 8 is a graph illustrating the relationship between the core loss and the temperature when the magnetic flux density Bm of the magnetic field is 100 mT and the frequency is 500 kHz for each of the core materials BH1, BH2, BH5.

In general, ferrite cores used in transformers and the like applied to power electronic devices are often used at lower than or equal to 120° C. As illustrated in FIG. 7 or 8, the core loss tends to decrease when the temperature of the core increases. When the temperature of the core exceeds a certain temperature, the core loss increases. When the core loss tends to decrease due to a temperature rise of the core, the core has a strong property (tolerance) against thermal runaway.

On the other hand, when the core loss increases due to the temperature rise of the core, the thermal runaway of the core is required to be sufficiently considered. For example, assuming that the core is used in a range where the temperature of the core is about 120° C. for the core material BH1 as illustrated in FIG. 7, the design is required to be performed in consideration of the thermal runaway on the assumption of the core loss of 200 kW/m³.

On the other hand, by applying core cooling structure 1 and setting the temperature of the core to be lower than or equal to 100° C. (Δ−20° C.), the core loss may be managed at about 155 kW/m³.

In addition, in a power supply using a new element such as SiC or GaN, high frequency driving is enabled, but on the other hand, there is a problem in that the core loss increases. Temperature management of the core and quantitative heat dissipation design can be performed by applying core cooling structure 1.

When the frequency is 500 kHz as illustrated in FIG. 8, for example, the core loss can be reduced by performing not thermal design in which the core loss of 1400 kW/m³ is secured by natural air cooling or circulating air, but more quantitative thermal design. For example, the core loss can be set to about 1200 kW/m³ by performing the quantitative thermal design capable of controlling the temperature of the core to about 90° C. (Δ−30° C.). Furthermore, mounting design that can downsize the core is also implemented.

In the conventional core, emphasis is placed on the surface area of the core in order to improve the heat dissipation of the core. On the other hand, in the core cooling structure described above, it is not necessary to design the core to be larger than necessary. When the core does not become larger than necessary, the core loss can be reduced, performance as a core can be improved, which contributes to resource saving and cost reduction.

(Power Conversion Device to which Core Cooling Structure is Applied)

### First Example

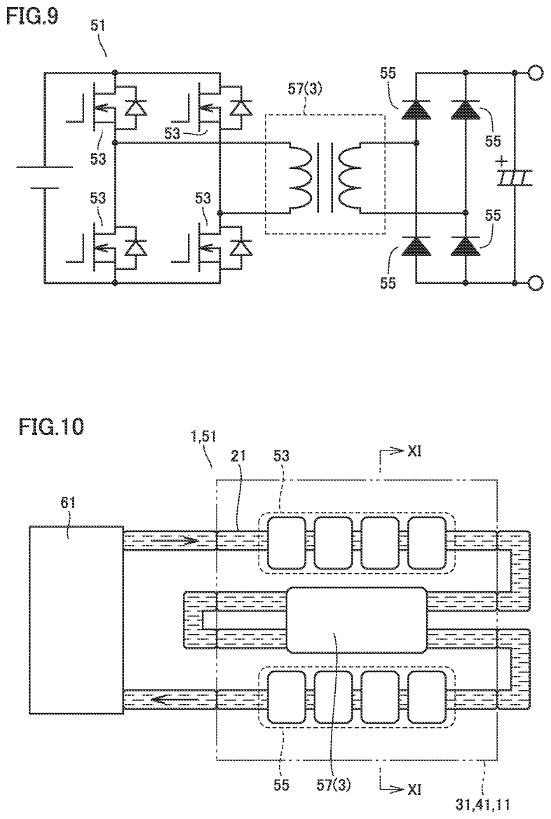

A first example of the power conversion device to which core cooling structure 1 is applied will be described below. At this point, a bridge inverter DC to DC converter is exemplified as an example of the power conversion device. FIG. 9 illustrates an example of a circuit diagram of the DC to DC converter. The DC to DC converter is a device that converts a DC power supply voltage input to an electronic device or the like into a required DC power supply voltage.

The DC power supply voltage input to the DC to DC converter is converted into an AC voltage by a switching element 53 such as a metal oxide semiconductor field effect transistor (MOSFET). The power supply voltage converted into the AC voltage is converted into an AC voltage corresponding to the required power supply voltage by a transformer 57. The power supply voltage converted into the AC voltage is rectified by a diode 55 and output as a required DC power supply voltage.

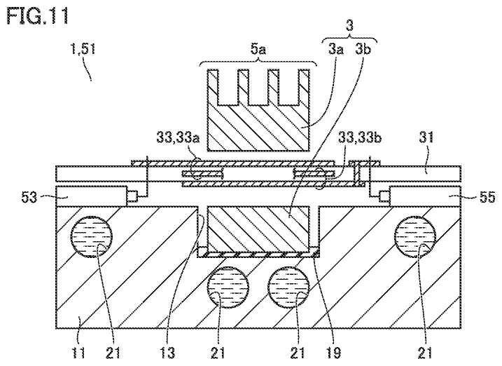

A structure of a power conversion device 51 will be specifically described below. As illustrated in FIGS. 10, 11, and 12, core cooling structure 1 is applied in power conversion device 51. Core 3 is mounted on a printed circuit board 31. The switching element, diode 55, and the like are attached to housing 11. Switching element 53 and diode 55 are disposed so as to be sandwiched between printed circuit board 31 and housing 11.

Core 3 of transformer 57 includes upper core 3a and lower core 3b. Fin 5a is formed in upper core 3a. Each of upper core 3a and lower core 3b is the E-type. Upper core 3a and lower core 3b are disposed so as to sandwich printed circuit board 31, and leg 3aa of corresponding upper core 3a and leg 3bb of corresponding lower core 3b are in contact with each other through through-hole 31a. Lower core 3b is fitted in recess 13 of housing 11 with TIM 19 interposed therebetween.

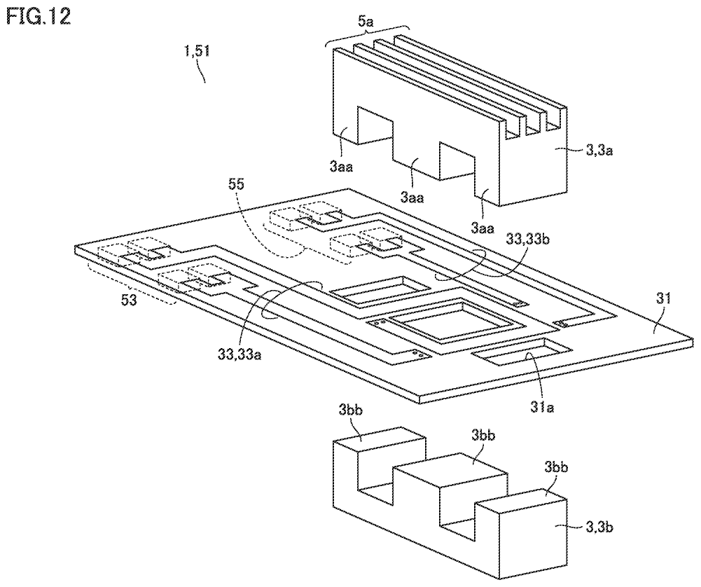

The winding constituting core 3 of the transformer is constituted by wiring pattern 33 formed on printed circuit board 31. A multilayer structure in which a plurality of printed circuit boards are stacked is adopted in printed circuit board 31. In FIGS. 11 and 12, printed circuit board 31 is illustrated as one printed circuit board in order to avoid complexity of the drawing.

A primary-side winding (voltage V1, number of turns n1) electrically connected to switching element 53 is configured by a wiring pattern 33a. Wiring pattern 33a is formed on an upper printed circuit board and a middle (inner) printed circuit board. A secondary-side winding (voltage V2, number of turns n2) electrically connected to diode 55 is configured by a wiring pattern 33b. Wiring pattern 33b is formed on a lowermost printed circuit board and a middle (inner) printed circuit board.

A cooling passage 21 as a heat dissipation unit is formed in housing 11. For example, cooling water flows through cooling passage 21. Cooling passage 21 is disposed such that the cooling water sequentially flows in a region immediately below switching element 53, a region immediately below core 3, and a region immediately below diode 55. Cooling passage 21 is connected to a cooling device 61 that cools the cooling water.

In power conversion device 51 to which core cooling structure 1 is applied, fin 5a is formed in upper core 3a, and lower core 3b is attached to recess 13 of housing 11. In addition, cooling passage 21 cooling switching element 53, diode 55, and core 3 is disposed in housing 11, and the cooling water flows in cooling passage 21. Thus, heat generated from switching element 53, diode 55, and core 3 can be efficiently dissipated from housing 11.

Regarding the heat dissipation, the quantitative heat dissipation design can be performed based on the thermal conductivity of core 3, the thermal conductivity of TIM 19, and the thermal conductivity of housing 11 and the like. In particular, because core 3 can be quantitatively thermally designed, the size required for core 3 can be reduced to the minimum necessary.

When thermal resistance of housing 11 is low and power conversion device 51 can be sufficiently cooled by the cooling water flowing through cooling passage 21, the cooling passage may not be disposed in a portion of housing 11 immediately below core 3 of the transformer. In addition, the wall thickness of housing 11 may be the minimum necessary. Although the case where the cooling water flows through cooling passage 21 has been described, the cooling water is not limited to the cooling water, and a liquid to which cooling oil or antifreeze liquid is added may flow flows through cooling passage 21. In addition, a refrigerant used for an air conditioner or the like may flow.

### Second Example

The power conversion device in which the refrigerant flows in the cooling passage will be described as a second example of the power conversion device to which core cooling structure 1 is applied.

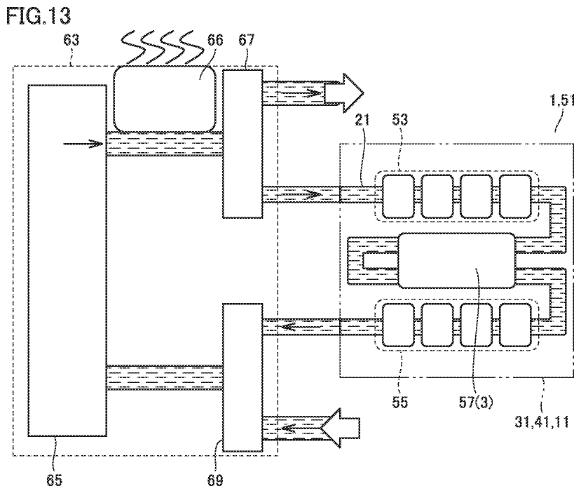

As illustrated in FIG. 13, a cooler 63 including a compressor 65, a decompression unit 67, and a recovery unit 69 is applied as a heat dissipation unit to power conversion device 51. A path (cooling passage 21) through which the refrigerant is supplied to power conversion device 51 and a path (see double arrows) through which the refrigerant is supplied to a cooling device (not illustrated) that is usually used other than power conversion device 51 are connected in parallel to cooler 63. Because other configurations are similar to those of power conversion device 51 in FIG. 10 and the like, the same members are denoted by the same reference numerals, and the description thereof will not be repeated unless necessary.

In power conversion device 51, the high-temperature refrigerant compressed by compressor 65 is dissipated in a heat dissipation unit 66, and then decompressed in decompression unit 67. The refrigerant reduced in pressure and lowered in temperature sequentially cools switching element 53, core 3, and diode 55. The refrigerant that cools diode 55 is recovered by recovery unit 69 and compressed again by compressor 65. Hereinafter, this cycle is repeated.

According to power conversion device 51 described above, similarly to the case of power conversion device 51 of the first example, the heat generated from switching element 53, diode 55, and core 3 can be efficiently dissipated from housing 11 through the refrigerant. Regarding the heat dissipation, the quantitative heat dissipation design can be performed based on the thermal conductivity of core 3, the thermal conductivity of TIM 19, and the thermal conductivity of housing 11 and the like.

In power conversion device 51 described above, the case where the path (cooling passage 21) through which the refrigerant is supplied to power conversion device 51 and the path (see double arrows) through which the refrigerant is supplied to the usually-used cooling device are connected in parallel to cooler 63 has been described. However, these paths may be connected in series.

### Third Example

The power conversion device to which an air cooling fin is applied will be described as a third example of the power conversion device to which core cooling structure 1 is applied.

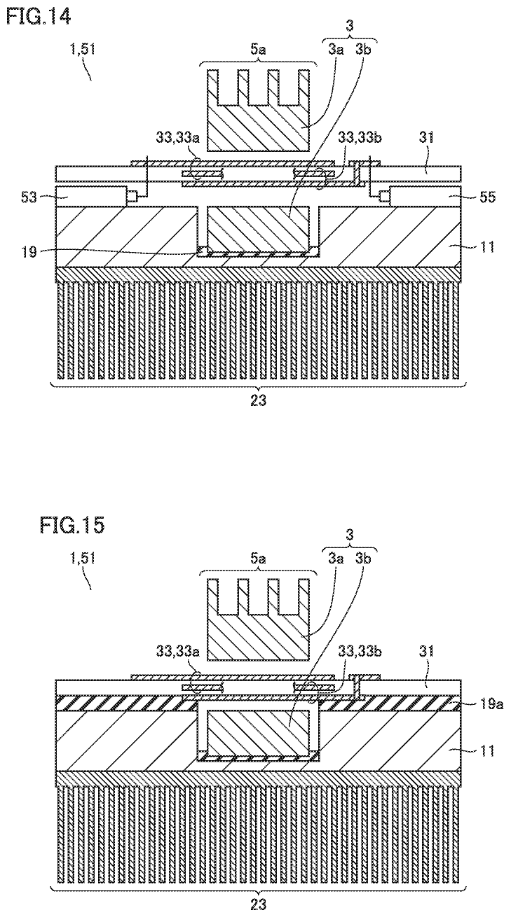

As illustrated in FIG. 14, in the power conversion device 51, an air cooling fin 23 is provided in housing 11. The switching element, diode 55, and the like are attached to housing 11. Switching element 53 and diode 55 are disposed so as to be sandwiched between printed circuit board 31 and housing 11.

Because other configurations are similar to those of power conversion device 51 to which core cooling structure 1 in FIGS. 1 and 2 and the like is applied, the same members are denoted by the same reference numerals, and the description thereof will not be repeated unless necessary.

In power conversion device 51 described above, the heat generated in switching element 53, diode 55, and core 3 is conducted to air cooling fin 23 through housing 11. The heat conducted to air cooling fins 23 is dissipated by natural air cooling or forced air cooling. At this point, because the heat is accumulated in housing 11 by specific heat, housing 11 also functions as a heat spreader. The heat generated in core 3 is dissipated by fin 5a.

### Fourth Example

The power conversion device to which the air cooling fin is applied will be described as a fourth example of the power conversion device to which core cooling structure 1 is applied.

As illustrated in FIG. 15, in power conversion device 51, air cooling fin 23 is provided in housing 11. The surface-mounted switching element, diode (not illustrated), and the like are mounted on printed circuit board 31. A TIM 19a is sandwiched between printed circuit board 31 and housing 11.

Because other configurations are similar to those of power conversion device 51 to which core cooling structure 1 in FIGS. 1 and 2 and the like is applied, the same members are denoted by the same reference numerals, and the description thereof will not be repeated unless necessary.

In power conversion device 51, heat generated in the switching element, the diode, the wiring (none of which is illustrated), or the like mounted on printed circuit board 31 is conducted to housing 11 through printed circuit board 31 and TIM 19. Similarly to the third example, the heat conducted to housing 11 is conducted to air cooling fin 23, and dissipated by natural air cooling or forced air cooling. In addition, because the heat is accumulated in housing 11 by specific heat, housing 11 also functions as a heat spreader. Furthermore, the heat generated in core 3 is dissipated by fin 5a.

### Second Embodiment

### First Example

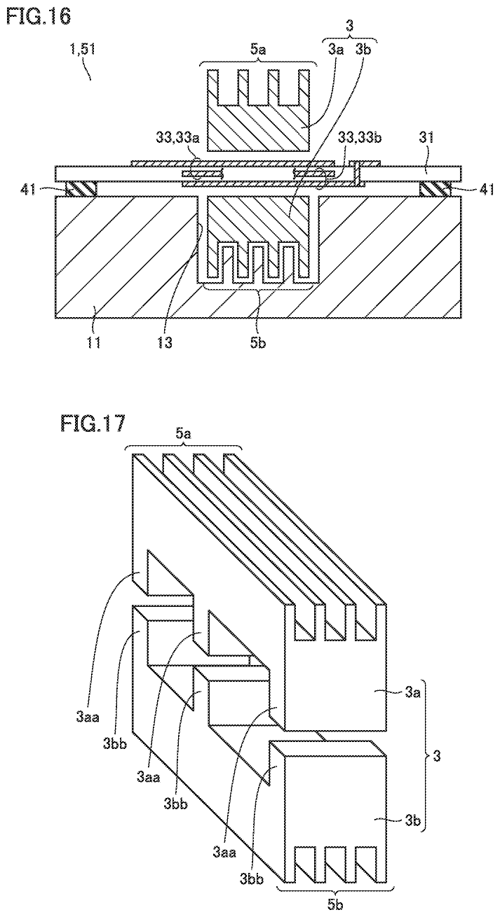

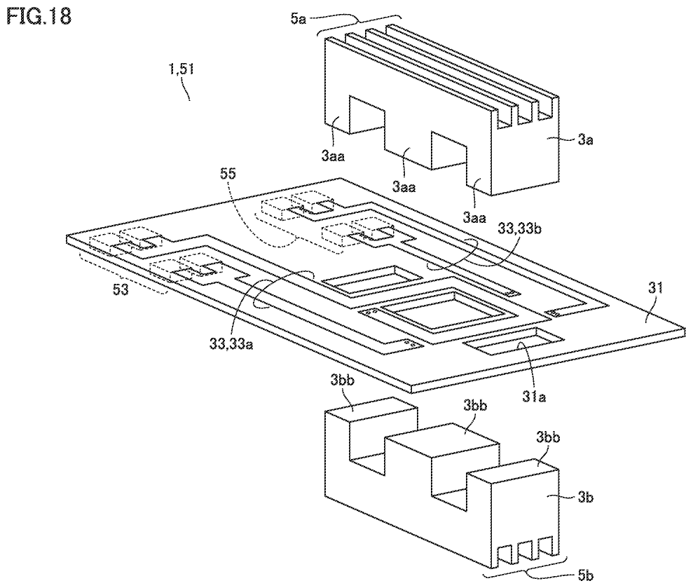

A first example of a power conversion device including a core cooling structure according to a second embodiment will be described. As illustrated in FIGS. 16, 17, and 18, core cooling structure 1 is applied in power conversion device 51. Core 3 is mounted on a printed circuit board 31. Switching element 53 and diode 55 are disposed so as to be sandwiched between printed circuit board 31 and housing 11.

Core 3 of transformer 57 includes upper core 3a and lower core 3b. Fin 5a is formed in upper core 3a. A Fin 5b is formed in lower core 3b. Each of upper core 3a and lower core 3b is the E-type. Upper core 3a and lower core 3b are disposed so as to sandwich printed circuit board 31, and leg 3aa of corresponding upper core 3a and leg 3bb of corresponding lower core 3b are in contact with each other through through-hole 31a.

Recess 13 corresponding to the shape of lower core 3b including fin 5b is formed in housing 11. Lower core 3b is fitted into recess 13 of housing 11. Because other configurations are similar to those of power conversion device 51 and the like in FIG. 1 and the like, the same members are denoted by the same reference numerals, and the description thereof will not be repeated unless necessary.

In power conversion device 51 described above, the following effects can be obtained in addition to the effects of power conversion device 51 described in the first embodiment.

Recess 13 corresponding to the shape of lower core 3b including fin 5b is formed in housing 11. Thus, core 3 including lower core 3b can be easily positioned, and power conversion device 51 can be easily assembled. In addition, the contact area between lower core 3b and housing 11 increases, and the TIM is not necessarily interposed.

Furthermore, in core 3, upper core 3a and lower core 3b have the same shape, and the molding die that molds core 3 can be narrowed down to one. In addition, two types of components are not required to be managed, and cost reduction and productivity improvement can be achieved.

### Second Example

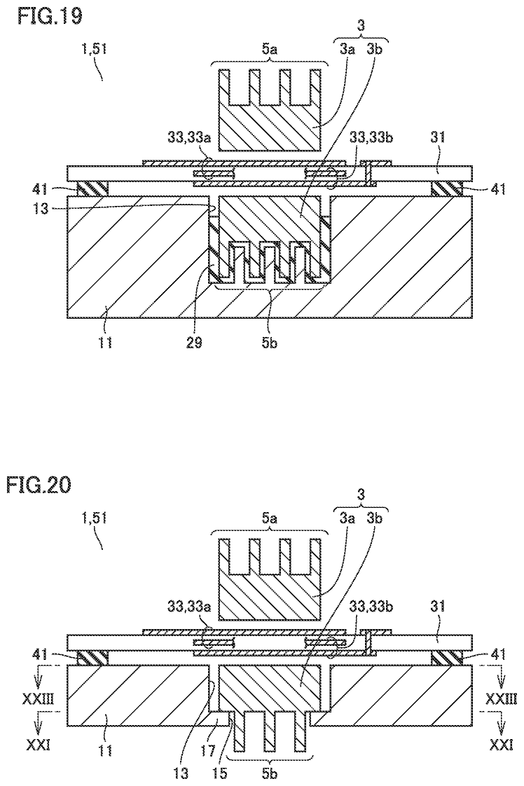

As illustrated in FIG. 19, in the second example of power conversion device 51, a filler 29 is injected between lower core 3b having fin 5b and housing 11. Examples of filler 29 include a thermally conductive resin and a potting material.

In the second example of power conversion device 51, because lower core 3b is fitted in recess 13 of housing 11 with filler 29 interposed therebetween, the contact thermal resistance between lower core 3b and housing 11 can be decreased, and power conversion device 51 can be efficiently cooled.

In addition, for example, TIM 19a may be sandwiched between printed circuit board 31 and housing 11 similarly to the case in FIG. 15, and printed circuit board 31 can be effectively cooled.

### Third Embodiment

### First Example

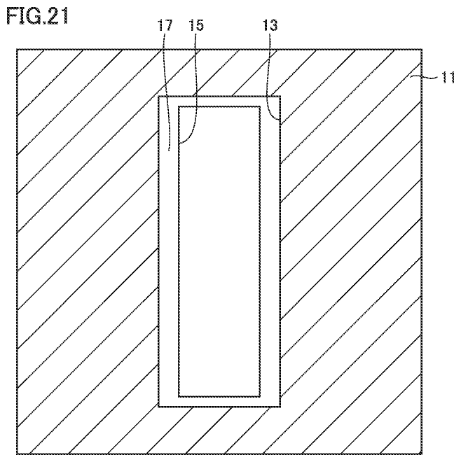

A first example of a power conversion device according to a third embodiment will be described. As illustrated in FIG. 20, in power conversion device 51, fin 5b of lower core 3b is exposed from housing 11. In addition to recess 13, an opening 15 penetrating housing 11 is formed in housing 11. As illustrated in FIG. 21, a stepped unit 17 is formed around opening 15.

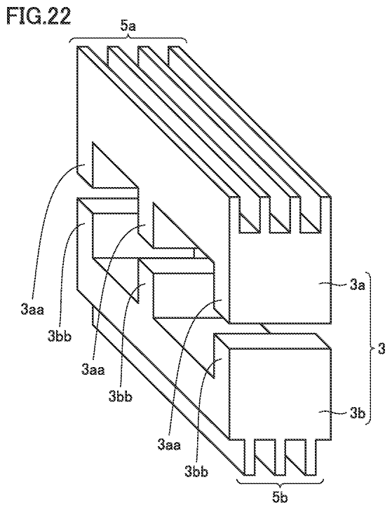

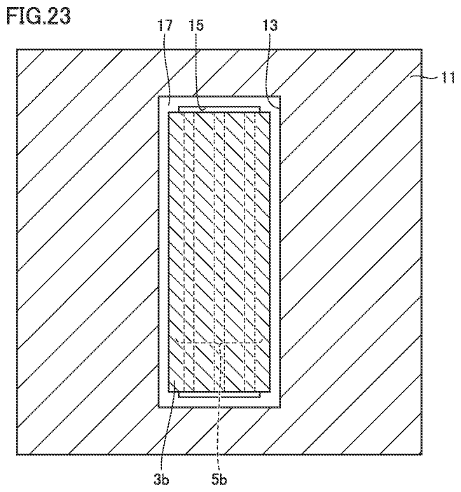

As illustrated in FIG. 22, upper core 3a of core 3 is the E-type, and lower core 3b is also the E-type. A portion in which fin 5b is not located is provided in lower core 3b, the portion being in contact with stepped unit 17. As illustrated in FIGS. 23 and 20, fin 5b is exposed from opening 15 while lower core 3b is placed on stepped unit 17.

Because other configurations are similar to those of power conversion device 51 and the like in FIG. 16 and the like, the same members are denoted by the same reference numerals, and the description thereof will not be repeated unless necessary.

In power conversion device 51 described above, the following effects can be obtained in addition to the effects of power conversion device 51 described in the first embodiment. In power conversion device 51, fin 5b of lower core 3b is exposed from opening 15 of housing 11. Thus, core 3 can be forcibly air-cooled, and the heat can be more effectively dissipated from core 3.

In addition, because the heat dissipation performance from core 3 is enhanced, when the heat dissipation performance is the same, core 3 can be downsized, and the downsized transformer or reactor can be mounted on the power electronics device. Furthermore, the TIM is not necessarily interposed between housing 11 and lower core 3b.

In addition, in the power electronic device, when the cooling air cooling other mounted semiconductor components or the like can be shared, the further downsizing and cost reduction of the power electronics device can be contributed to.

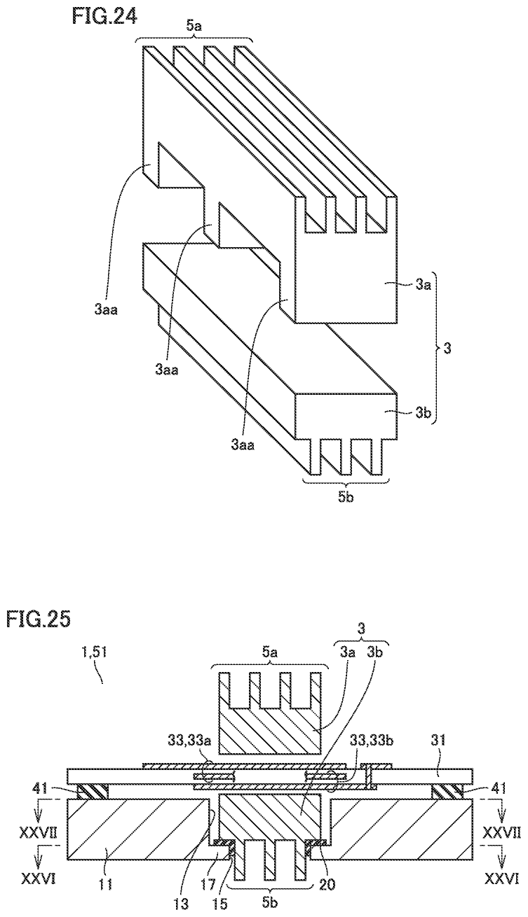

The case where both upper core 3a and lower core 3b are the E-type as core 3 has been described as an example. However, as illustrated in FIG. 24, upper core 3a may be the E-type and lower core 3b may be the I-type.

In core 3 of FIGS. 22 and 24, the number of fins 5a of upper core 3a is four, whereas the number of fins 5b of lower core 3b is three. At this point, it is assumed that sometimes the heat dissipation amount from upper core 3a exceeds the heat dissipation amount from lower core 3b. Furthermore, also in the structure in which lower core 3b is fitted in recess 13 of housing 11, it is assumed that sometimes the heat dissipation amount from upper core 3a exceeds the heat dissipation amount from lower core 3b.

In power conversion device 51 described above, fin 5b of lower core 3b is forcibly air-cooled by being exposed from housing 11, and the heat dissipation from fin 5b of lower core 3b is promoted, so that the heat dissipation amount from upper core 3a and the heat radiation amount from lower core 3b can be balanced.

The shape including the number of fins 5a of upper core 3a and the shape including the number of fins 5b of lower core 3b may have the same shape. Even in this case, desirably the heat is dissipated after performing the design in consideration of the balance between the heat dissipation amount from upper core 3a and the heat dissipation amount from lower core 3b.

In this case, during the molding of the core, the molding die can be shared for upper core 3a and lower core 3b. In addition, two types of components are not required to be managed, and cost reduction and productivity improvement can be achieved.

### Second Example

A second example of the power conversion device according to the third embodiment will be described. As illustrated in FIG. 25, in power conversion device 51, a buffer material 20 is interposed between lower core 3b and housing 11.

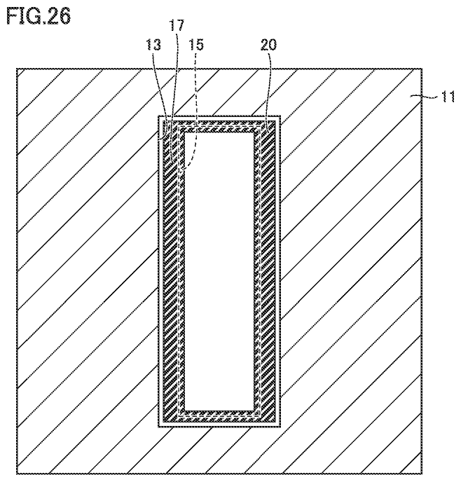

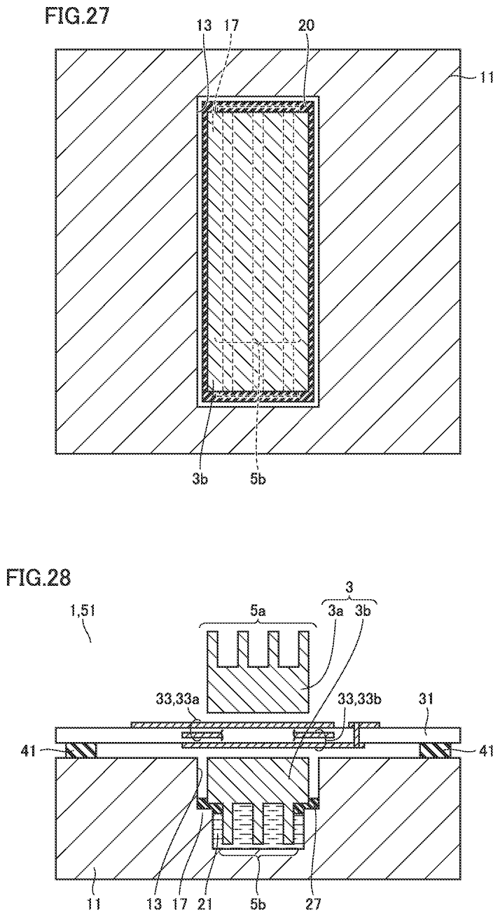

As illustrated in FIG. 26, stepped unit 17 is formed around opening 15. Buffer material 20 covers stepped unit 17, and is disposed so as to slightly enter the inside of opening 15. As illustrated in FIG. 27, lower core 3b is disposed so as to sandwich buffer material 20, which is disposed to be slightly inserted inside opening 15, between housing 11 and lower core 3b.

Because other configurations are similar to those of power conversion device 51 and the like in FIG. 20 and the like, the same members are denoted by the same reference numerals, and the description thereof will not be repeated unless necessary.

In power conversion device 51 described above, the following effects can be obtained in addition to the effects of power conversion device 51 of the first example. In power conversion device 51 described above, when lower core 3b of core 3 is attached to opening 15 of housing 11, lower core 3b can be prevented from being damaged by buffer material 20 that is disposed while slightly entering the inside of opening 15.

For example, when the TIM is applied as buffer material 20, the heat conduction from core 3 to housing 11 is promoted, which can contribute to the heat dissipation. In addition, a gasket can be applied as buffer material 20. Furthermore, sheet-shaped rubber or resin material used for an O-ring, a joint sheet, a Teflon (registered trademark) sheet, or the like can also be applied. In addition, for example, the TIM is interposed between printed circuit board 31 and housing 11 similarly to the case in FIG. 15, so that printed circuit board 31 can also be cooled.

### Fourth Embodiment

### First Example

A first example of a power conversion device according to a fourth embodiment will be described. As illustrated in FIG. 28, in power conversion device 51, cooling passage 21 is formed between lower core 3b and housing 11. For example, cooling water flows through cooling passage 21.

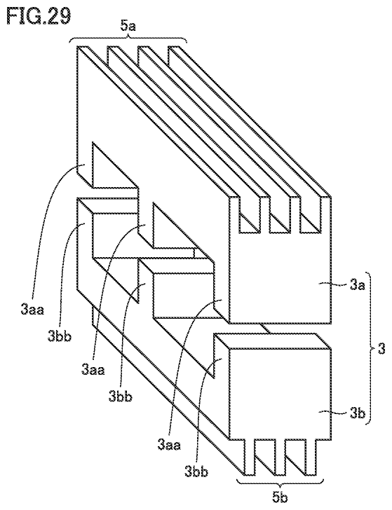

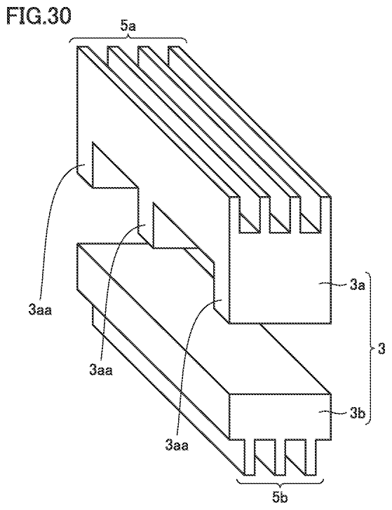

Lower core 3b is disposed on stepped unit 17 of housing 11 with a sealing material 27 interposed therebetween. Lower core 3b having fin 5b is disposed in order to effectively dissipate the heat. In addition, lower core 3b may be the E-type as illustrated in FIG. 29, or may be an I-type as illustrated in FIG. 30. Core 3 is directly cooled by the cooling water flowing through cooling passage 21. For example, the gasket or the TIM can be applied as sealing material 27.

Because other configurations are similar to those of power conversion device 51 and the like in FIG. 16 and the like, the same members are denoted by the same reference numerals, and the description thereof will not be repeated unless necessary.

In power conversion device 51 described above, the following effects can be obtained in addition to the effects described in the first embodiment. The heat generated in core 3 is directly dissipated to the cooling water flowing through cooling passage 21 through fin 5b of lower core 3b. Accordingly, high heat dissipation performance can be obtained. As a result, core 3 can be further downsized when having the same heat dissipation performance, and the downsized transformer or reactor can be mounted on the power electronic device.

In addition, in the power electronic device, when the cooling water cooling other mounted semiconductor components or the like can be shared, the further downsizing and cost reduction of the power electronics device can be contributed to. Furthermore, because core 3 can be directly cooled, the heat dissipation using another cooling environment disposed around housing 11 is also performed, which can contribute to the further downsizing and cost reduction of the power electronic device.

Although the case where the cooling water flows through cooling passage 21 has been described, it is not limited to the cooling water, and a liquid to which cooling oil or antifreeze liquid is added may flow through cooling passage 21. In addition, a refrigerant used for an air conditioner or the like may flow.

### Second Example

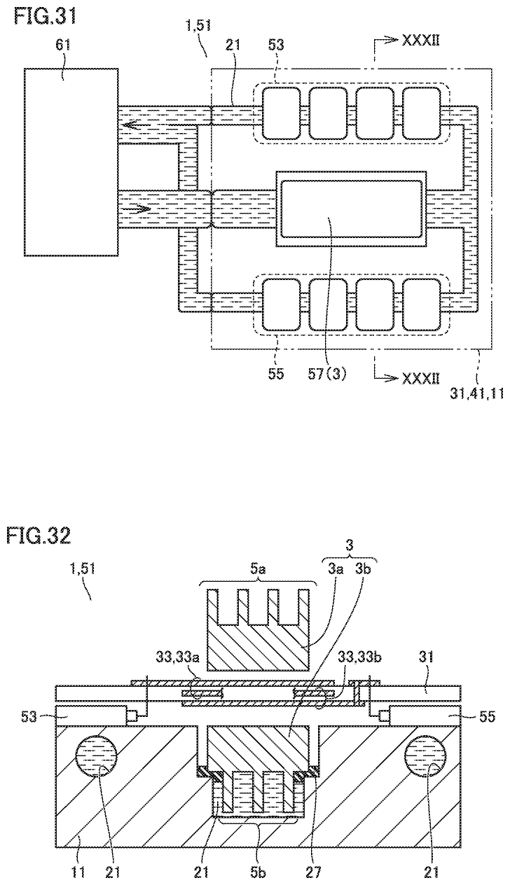

A second example of the power conversion device according to the fourth embodiment will be described. As illustrated in FIGS. 31 and 32, in power conversion device 51, cooling passage 21 is also disposed immediately below each of switching element 53 and diode 55 in addition to cooling passage 21 formed between lower core 3b and housing 11. For example, cooling water flows through cooling passage 21. Cooling passage 21 is connected to cooling device 61.

Because other configurations are similar to those of power conversion device 51 and the like in FIG. 10 and the like, the same members are denoted by the same reference numerals, and the description thereof will not be repeated unless necessary.

In power conversion device 51 described above, the following effects can be obtained in addition to the effects of power conversion device 51 of the first example. In housing 11, in addition to cooling passage 21 cooling core 3, a cooling passage 21 cooling switching element 53 and diode 55 is disposed, and the cooling water flows in cooling passage 21. Thus, heat generated from switching element 53, diode 55, and core 3 can be efficiently dissipated from housing 11.

Regarding the heat dissipation, the quantitative heat dissipation design can be performed based on the thermal conductivity of core 3, the thermal conductivity of housing 11, and the like. In particular, because core 3 can be quantitatively thermally designed, the size required for core 3 can be reduced to the minimum necessary.

Although the case where the cooling water flows through cooling passage 21 has been described, it is not limited to the cooling water, and a liquid to which cooling oil or antifreeze liquid is added may flow through cooling passage 21. In addition, a refrigerant used for an air conditioner or the like may flow. When the refrigerant is used, in consideration of leakage of the refrigerant, for example, structural strength is required to be secured for adhesion between sealing material 27 such as a gasket and lower core 3b.

In addition to the gasket, for example, a sheet-shaped rubber or resin material used for the O-ring, a joint sheet, a Teflon sheet, or the like can also be applied as sealing material 27.

In addition, in power conversion device 51 described above, in addition to the case where core 3 is first cooled by the cooling water and then switching element 53 and the like are cooled, the cooling water may be caused to flow such that switching element 53 is first cooled and then core 3 is cooled in consideration of the temperature rise of the cooling water flowing immediately below switching element 53.

For example, similarly to the case in FIG. 15, the TIM is interposed between printed circuit board 31 and housing 11, so that printed circuit board 31 can also be cooled.

### Fifth Embodiment

### First Example

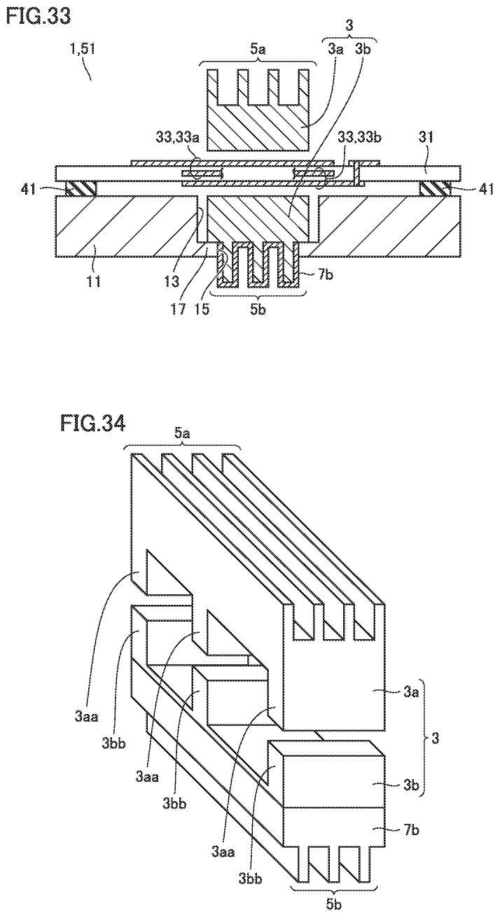

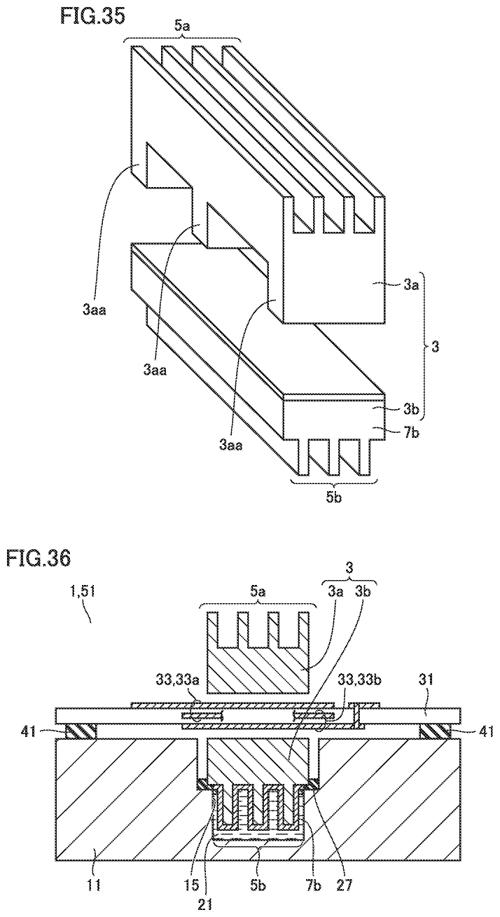

A first example of a power conversion device according to a fifth embodiment will be described. As illustrated in FIG. 33, in power conversion device 51, fin 5b of lower core 3b is exposed from opening 15 of housing 11. As illustrated in FIG. 34 or 35, an anticorrosion treatment unit 7b subjected to an anticorrosion treatment is formed on the surface of fin 5b.

Because other configurations are similar to those of power conversion device 51 and the like in FIG. 20 and the like, the same members are denoted by the same reference numerals, and the description thereof will not be repeated unless necessary.

For example, when the surface treatment is performed with a conductive material such as nickel plating in forming anticorrosion treatment unit 7b in lower core 3b, an induced current or an eddy current flows due to a magnetic field. For this reason, the surface treatment is not performed over the entire periphery of lower core 3b in the direction intersecting the magnetic field.

Even when the surface of the core is subjected to the surface treatment as much as possible, the mounting design is required to be performed such that the surface treatment is not performed on a portion where upper core 3a and lower core 3b are in contact with each other. As illustrated in FIG. 34, the surface treatment is not performed on the portion where leg 3aa and leg 3bb are in contact with each other. As illustrated in FIG. 35, the surface treatment is not performed on the portion where leg 3aa and lower core 3b are in contact with each other.

In addition, when the anticorrosion treatment unit is formed in core 3 using the conductive material, the anticorrosion treatment unit corresponds to one winding of the transformer at the maximum, and thus the voltage corresponding to the transformer winding ratio is generated at the end of the anticorrosion treatment unit. For this reason, an untreated portion where the anticorrosion treatment unit is not formed is required to be disposed such that the voltage at the anticorrosion treatment unit becomes lower than or equal to a surface insulation voltage at core 3.

In power conversion device 51 described above, the following effects can be obtained in addition to the effects of power conversion device 51 of the third embodiment. By forming anticorrosion treatment unit 7b in fin 5b of lower core 3b, for example, the high tolerance can be obtained to contamination of a corrosive substance such as a corrosive gas. In addition, core 3 can be easily handled by anticorrosion treatment unit 7b suppressing the damage caused by the impact on lower core 3b.

### Second Example

A second example of the power conversion device according to the fifth embodiment will be described. As illustrated in FIG. 36, in power conversion device 51, cooling passage 21 is formed between lower core 3b and housing 11. For example, cooling water flows through cooling passage 21. Anticorrosion treatment unit 7b subjected to the anticorrosion treatment is formed on the surface of fin 5b. Anticorrosion treatment unit 7b is formed only in a portion of cooling passage 21 in contact with the cooling water such that the voltage at anticorrosion treatment unit 7b is lower than or equal to the surface insulation voltage at core 3.

Because other configurations are similar to those of power conversion device 51 and the like in FIG. 28 and the like, the same members are denoted by the same reference numerals, and the description thereof will not be repeated unless necessary.

In power conversion device 51 described above, the following effects can be obtained in addition to the effects of power conversion device 51 of the fourth embodiment. By forming anticorrosion treatment unit 7b in fin 5b of lower core 3b, for example, the high tolerance can be obtained to the corrosive substance mixed in the cooling water. In addition, core 3 can be easily handled by anticorrosion treatment unit 7b suppressing the damage caused by the impact on lower core 3b. Furthermore, chipping or the like of the portion of cooling passage 21 is reduced, and durability of power conversion device 51 including cooling structure 1 of core 3 can be improved.

In the first example and the second example, for example, similarly to the case in FIG. 15, the TIM is interposed between printed circuit board 31 and housing 11, so that printed circuit board 31 can be cooled.

### Sixth Embodiment

In a sixth embodiment, a power conversion device including a lower housing to which a lower core is attached and an upper housing to which an upper core is attached as housings will be described.

### First Example

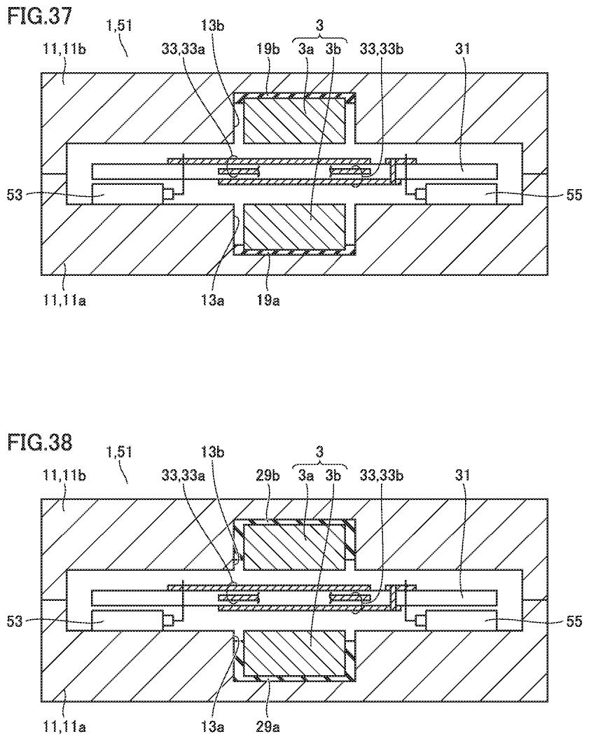

A first example of the power conversion device will be described. As illustrated in FIG. 37, power conversion device 51 including core cooling structure 1 includes a lower housing 11a and an upper housing 11b as housing 11. Lower housing 11a and upper housing 11b are disposed so as to sandwich printed circuit board 31 and core 3. Core 3 in which the fin is not formed is applied.

Lower core 3b is attached to lower housing 11a. Lower core 3b is fitted in a recess 13a formed in lower housing 11a with a TIM 19a interposed therebetween. Upper core 3a is attached to upper housing 11b. Upper core 3a is fitted in a recess 13b formed in upper housing 11b with a TIM 19b interposed therebetween.

Because other configurations are similar to those of power conversion device 51 and the like in FIG. 2 and the like, the same members are denoted by the same reference numerals, and the description thereof will not be repeated unless necessary.

### Second Example

A second example of the power conversion device will be described. As illustrated in FIG. 38, in power conversion device 51, lower core 3b is attached to lower housing 11a. Lower core 3b is fitted into recess 13a formed in lower housing 11a with a filler 29a interposed therebetween. Upper core 3a is attached to upper housing 11b. Upper core 3a is fitted in recess 13b formed in the upper housing 11b with a filler 29b interposed therebetween.

Because other configurations are similar to those of power conversion device 51 in FIG. 37, the same members are denoted by the same reference numerals, and the description thereof will not be repeated unless necessary.

### Third Example

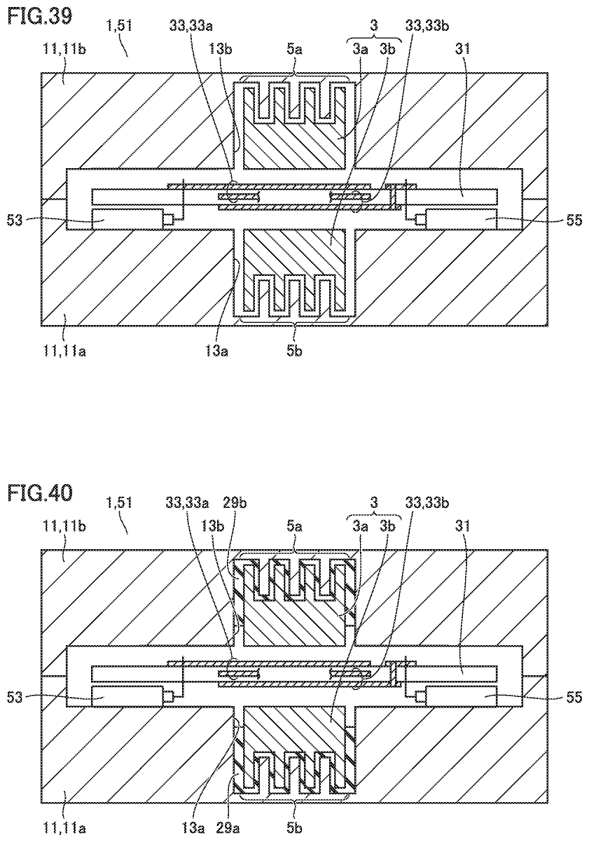

A third example of the power conversion device will be described. As illustrated in FIG. 39, in power conversion device 51, fin 5a is formed in upper core 3a. Fin 5b is formed in lower core 3b. Lower core 3b is attached to lower housing 11a. Upper core 3a is attached to upper housing 11b.

Lower core 3b is fitted into recess 13a formed in lower housing 11a. Upper core 3a is fitted into recess 13b formed in upper housing 11b. Because other configurations are similar to those of power conversion device 51 and the like in FIG. 16 and the like, the same members are denoted by the same reference numerals, and the description thereof will not be repeated unless necessary.

### Fourth Example

A fourth example of the power conversion device will be described. As illustrated in FIG. 40, in power conversion device 51, lower core 3b is attached to lower housing 11a. Lower core 3b is fitted into recess 13a formed in lower housing 11a with a filler 29a interposed therebetween. Upper core 3a is attached to upper housing 11b. Upper core 3a is fitted in recess 13b formed in the upper housing 11b with a filler 29b interposed therebetween.

Because other configurations are similar to those of power conversion device 51 and the like in FIG. 39, the same members are denoted by the same reference numerals, and the description thereof will not be repeated unless necessary.

In each of power conversion devices 51 of the first to fourth examples, core 3 includes upper core 3a and lower core 3b, and housing 11 includes upper housing 11b and lower housing 11a. Lower core 3b is attached to lower housing 11a. Upper core 3a is attached to upper housing 11b.

Thus, the heat dissipation amount from upper core 3a and the heat dissipation amount from lower core 3b can be designed so as to be the same heat dissipation amount. For this reason, the heat dissipation design is simplified, and the cooling can be performed such that the difference in the heat dissipation amount between upper core 3a and lower core 3b becomes smaller. As a result, core 3 of the transformer can be further downsized. In addition, the performance as core 3 can be easily stabilized.

A variation of the power conversion device including the cooling structure by the air cooling or the water cooling will be described below as still another example of the power conversion device.

### Fifth Example

A fifth example of the power conversion device will be described. As illustrated in FIG. 41, an air cooling fin 23b is attached to upper housing 11b. An air cooling fin 23a is attached to lower housing 11a. Because other configurations are similar to those of power conversion device 51 in FIG. 37, the same members are denoted by the same reference numerals, and the description thereof will not be repeated unless necessary.

Air cooling fins 23a, 23b can also be applied to power conversion device 51 in each of FIGS. 38 to 40 in addition to power conversion device 51 in FIG. 37.

### Sixth Example

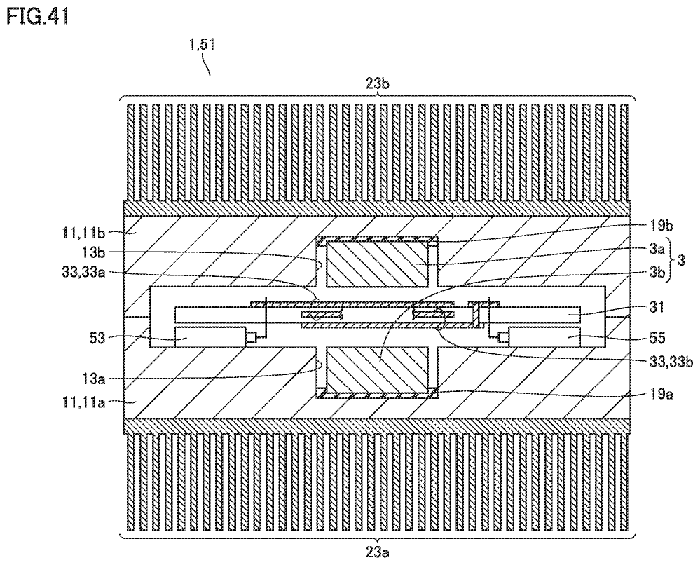

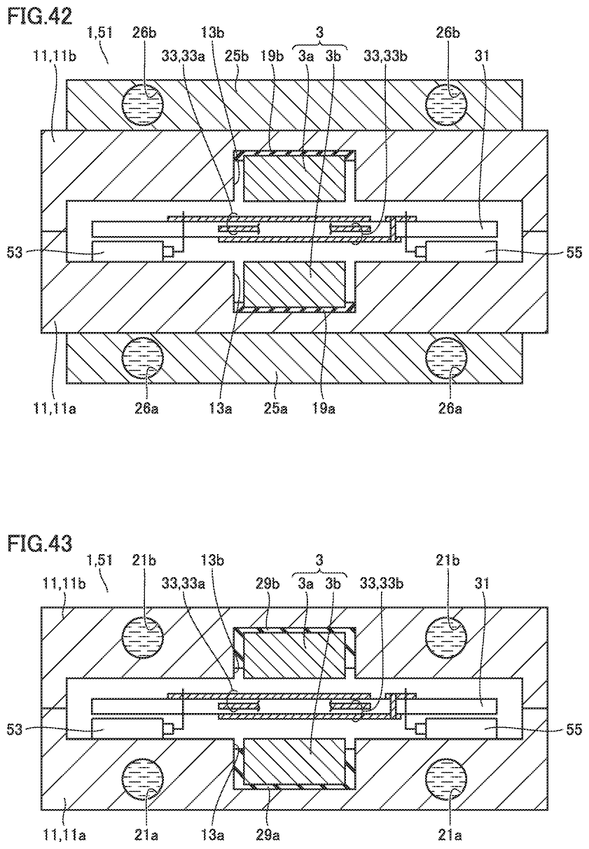

A sixth example of the power conversion device will be described. As illustrated in FIG. 42, a water cooling fin 25b is attached to upper housing 11b. A water cooling fins 25a are attached to lower housing 11a. A cooling passage 26b is provided in a water cooling fin 25b. A cooling passage 26a is provided in water cooling fin 25a.

Because other configurations are similar to those of power conversion device 51 in FIG. 37, the same members are denoted by the same reference numerals, and the description thereof will not be repeated unless necessary. Water cooling fins 25a, 25b can be applied not only to power conversion device 51 in FIG. 37 but also to power conversion device 51 in each of FIGS. 38 to 40.

### Seventh Example

A seventh example of the power conversion device will be described. As illustrated in FIG. 43, a cooling passage 21b is formed in upper housing 11b. A cooling passage 21a is formed in lower housing 11a. Because other configurations are similar to those of power conversion device 51 in FIG. 38, the same members are denoted by the same reference numerals, and the description thereof will not be repeated unless necessary.

### Eighth Example

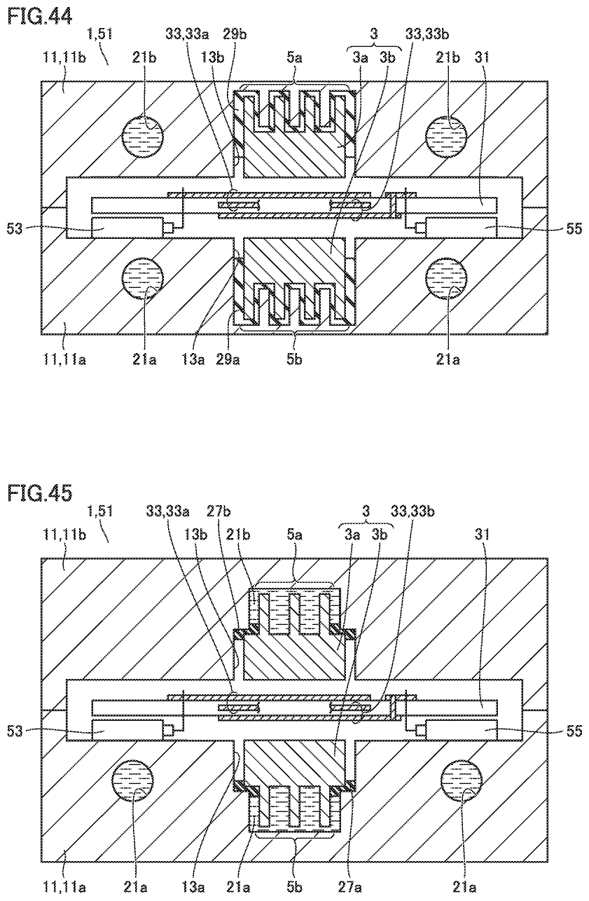

An eighth example of the power conversion device will be described. As illustrated in FIG. 44, cooling passage 21b is formed in upper housing 11b. A cooling passage 21a is formed in lower housing 11a. Because other configurations are similar to those of power conversion device 51 in FIG. 40, the same members are denoted by the same reference numerals, and the description thereof will not be repeated unless necessary.

### Ninth Example

A ninth example of the power conversion device will be described. As illustrated in FIG. 45, in power conversion device 51, lower core 3b is fitted into recess 13a formed in lower housing 11a with a sealing material 27a interposed therebetween. Cooling passage 21a is formed between lower core 3b and lower housing 11a. Cooling passage 21a is further formed in lower housing 11a.

Upper core 3a is fitted into recess 13b formed in upper housing 11b with a sealing material 27b interposed therebetween. Cooling passage 21b is formed between upper core 3a and upper housing 11b. For example, the cooling water flows through cooling passages 21a, 21b. Because other configurations are similar to those of power conversion device 51 in FIG. 22, the same members are denoted by the same reference numerals, and the description thereof will not be repeated unless necessary.

### Tenth Example

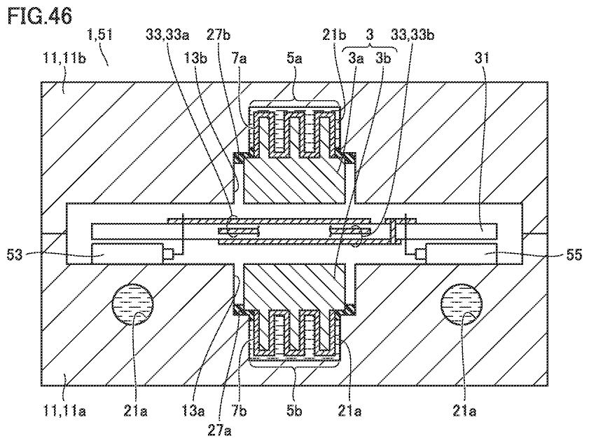

A tenth example of the power conversion device will be described. As illustrated in FIG. 46, in power conversion device 51, as illustrated in FIG. 46, anticorrosion treatment unit 7b is formed on the surface of fin 5b of lower core 3b. Anticorrosion treatment unit 7b is formed in a portion of fin 5b in contact with the cooling water flowing through cooling passage 21a.

An anticorrosion treatment unit 7a is formed on the surface of fin 5a of upper core 3a. Anticorrosion treatment unit 7a is formed in a portion of fin 5a in contact with the cooling water flowing through cooling passage 21b. Because other configurations are similar to those of power conversion device 51 in FIG. 45, the same members are denoted by the same reference numerals, and the description thereof will not be repeated unless necessary.

The effects similar to the effects of corresponding power conversion device 51 described in the first to sixth embodiment can be obtained in the power conversion devices of the fifth to tenth examples described as the variations of the power conversion device including the cooling structure by the air cooling or the water cooling.

In addition, in the variation of power conversion device 51, the cooling is efficiently performed, and for example, the thermal resistance of housing 11 in a lateral direction is reduced by using the TIM as the filler, and the size of housing 11 is reduced as much as possible, thereby downsizing power conversion device 51 having the cooling structure.

Furthermore, depending on the thermal design temperature of core 3, for example, a simple TIM such as a sheet or grease may be used with no use of the TIM as the filler. Furthermore, as illustrated in FIG. 11, the cooling passage may be further provided in a portion of housing 11 in a vicinity of core 3 (lower core 3b).

As described above, not only the cooling water but also the liquid to which the cooling oil or the antifreeze liquid is added may flow through cooling passage 21. In addition, a refrigerant used for an air conditioner or the like may flow. In addition, for example, the TIM is interposed between printed circuit board 31 and housing 11 similarly to the case in FIG. 15, so that printed circuit board 31 can also be cooled.

### Seventh Embodiment

### First Example

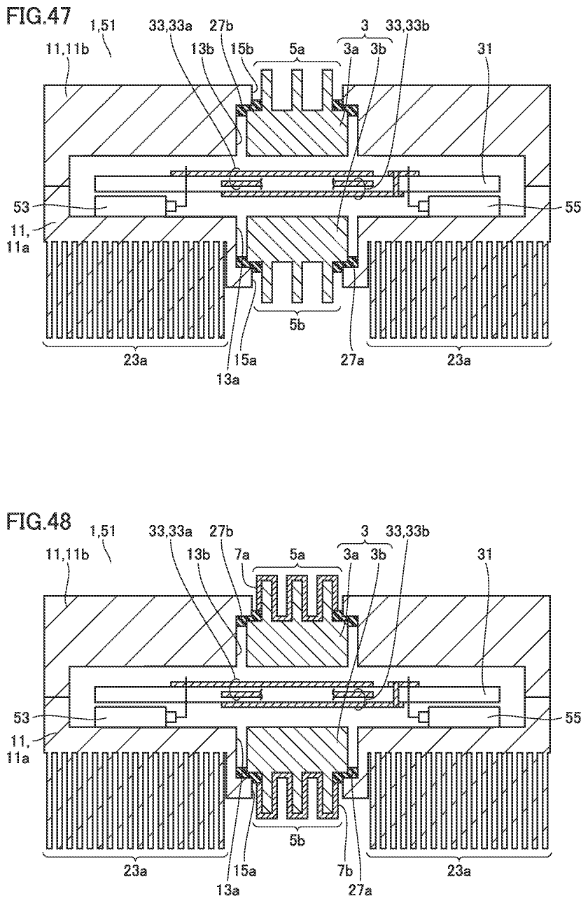

A first example of a power conversion device according to a seventh embodiment will be described. As illustrated in FIG. 47, in power conversion device 51, lower core 3b is attached to lower housing 11a with sealing material 27a interposed therebetween. Fin 5b of lower core 3b is exposed from lower housing 11a. In lower housing 11a, an opening 15a penetrating lower housing 11a is formed in addition to recess 13a. Fin 5b is exposed from opening 15a. Air cooling fin 23a is provided in lower housing 11a.

Upper core 3a is attached to upper housing 11b with sealing material 27b interposed therebetween. Fin 5a of upper core 3a is exposed from upper housing 11b. In upper core 3a, an opening 15b penetrating upper housing 11b is formed in addition to recess 13b. Fin 5a is exposed from opening 15b. Because other configurations are similar to those of power conversion device 51 in FIG. 25 and the like, the same members are denoted by the same reference numerals, and the description thereof will not be repeated unless necessary.

In power conversion device 51, both fin 5a of upper core 3a and fin 5b of lower core 3b are exposed from housing 11. Thus, in the cooling of core 3, divided upper core 3a and lower core 3b can be cooled to the same extent, and core 3 (transformer) can be further downsized. In addition, core 3 can be used in a region where a characteristic is stabilized. In power conversion device 51, the air cooling fin may also be provided in upper housing 11b.

### Second Example

A second example of the power conversion device according to the seventh embodiment will be described. As illustrated in FIG. 48, in power conversion device 51, fin 5b of lower core 3b is exposed from lower housing 11a. Anticorrosion treatment unit 7a is formed on the exposed surface of fin 5b. Fin 5a of upper core 3a is exposed from upper housing 11b. Anticorrosion treatment unit 7b is formed on the exposed surface of fin 5a.

Because other configurations are similar to those of power conversion device 51 in FIG. 47, the same members are denoted by the same reference numerals, and the description thereof will not be repeated unless necessary.

In power conversion device 51 described above, the following effects can be obtained in addition to the effects of power conversion device 51 of the first example. That is, anticorrosion treatment units 7a, 7b are formed on the surfaces of the exposed fins 5a, 5b, respectively. Thus, for example, fins 5a, 5b can have strong tolerance even under an environment where a corrosive gas may be generated.

In the first example and the second example, as described above, for example, similarly to the case in FIG. 15, the TIM is interposed between printed circuit board 31 and housing 11, so that printed circuit board 31 can be cooled.

### Third Example

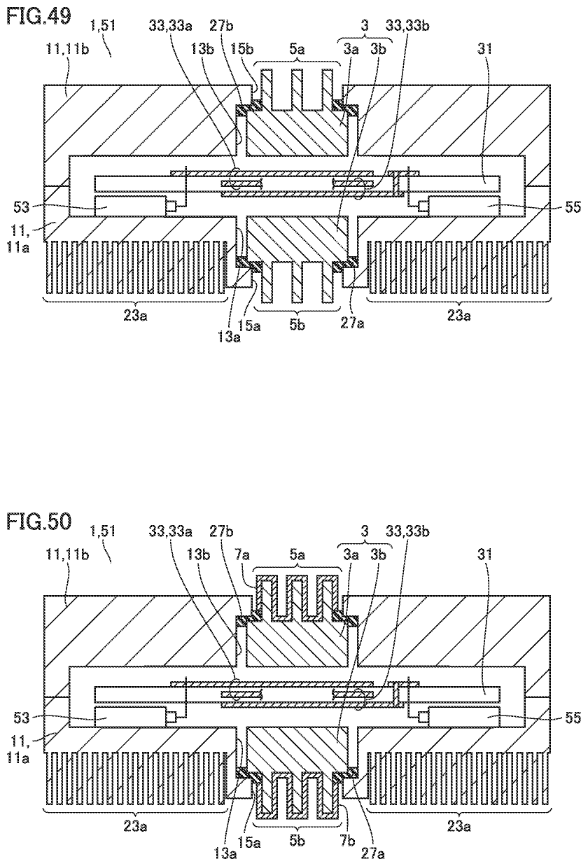

A third example of the power conversion device according to the seventh embodiment will be described. In the power conversion device of the third example, the length of air cooling fin 23a extending downward is different from the length of air cooling fin 23a in the power conversion device of the first example. As illustrated in FIG. 49, in the lower housing 11a of power conversion device 51 of the third example, air cooling fin 23a is formed so as to be positioned above the lower end of fin 5b.

Because other configurations are similar to those of power conversion device 51 in FIG. 47, the same members are denoted by the same reference numerals, and the description thereof will not be repeated unless necessary.

In power conversion device 51 described above, because air cooling fin 23a is positioned above the lower end of fin 5b, power conversion device 51 can be downsized in addition to the cooling effect.

### Fourth Example

A fourth example of the power conversion device according to the seventh embodiment will be described. In the power conversion device of the fourth example, the length of air cooling fin 23a extending downward is different from the length of air cooling fin 23a in the power conversion device of the second example. As illustrated in FIG. 50, in lower housing 11a of power conversion device 51 of the fourth example, air cooling fin 23a is formed so as to be positioned above the lower end of fin 5b.

Because other configurations are similar to those of power conversion device 51 in FIG. 48, the same members are denoted by the same reference numerals, and the description thereof will not be repeated unless necessary.

In power conversion device 51 described above, because air cooling fin 23a is positioned above the lower end of fin 5b, power conversion device 51 can be downsized in addition to the cooling effect.

### Eighth Embodiment

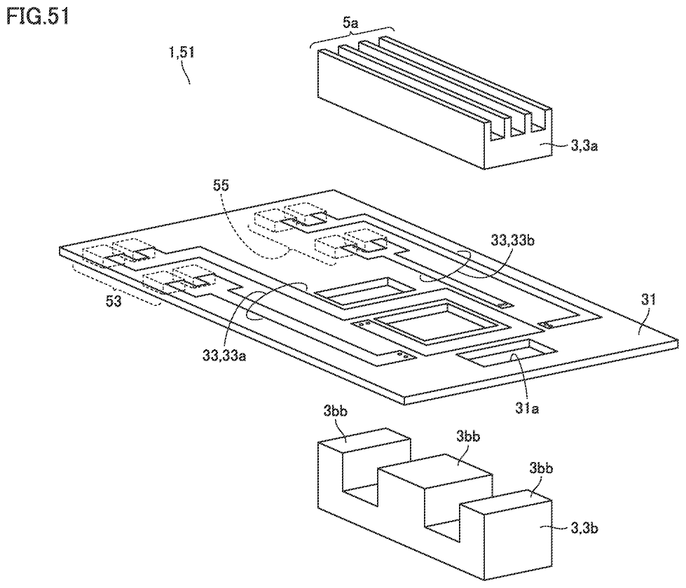

A power conversion device 51 according to an eighth embodiment will be described. As illustrated in FIG. 51, core 3 includes upper core 3a and lower core 3b. Upper core 3a is the I-type having the shape of the alphabet “I”. Lower core 3b is the E-type having the shape of the alphabet “E”. E-type lower core 3b has three legs 3bb.

A through-hole 31a corresponding to leg 3bb is made in printed circuit board 31. Upper core 3a and lower core 3b are disposed so as to face each other in such a manner that leg 3bb is inserted into through-hole 31a to sandwich printed circuit board 31 between upper core 3a and lower core 3b. Because other configurations are similar to those of power conversion device 51 in FIGS. 1 to 3 and the like, the same members are denoted by the same reference numerals, and the description thereof will not be repeated unless necessary.

In power conversion device 51, fin 5a is formed in I-type upper core 3a. Thus, the heat of upper core 3a is dissipated by fin 5a. Lower core 3b is in contact with housing 11 (see FIG. 2 and the like). Lower core 3b is fitted into housing 11 through TIM 19 (see FIG. 2 and the like). Thus, the heat of lower core 3b is dissipated by housing 11. As a result, the heat of core 3 is efficiently dissipated, and core 3 can be cooled.

In upper core 3a of core 3, fin 5a extends in one direction along the magnetic path. As a result, as described in the first embodiment and the like, fin 5a can secure the sectional area as the core in which the magnetic path is formed, and for example, can obtain the stable characteristic as the transformer or the reactor.

In power conversion device 51 described above, productivity can be further greatly improved. This will be described.

In general, the core is formed by compacting a granular material of less than or equal to several 100 μm such as a dust core or a ferrite core into a desired shape and sintering the granular material. For this reason, productivity of the core is considered to be relatively good.

As described above, I-type upper core 3a extends in one direction, and the sectional shape as a first sectional shape along the other direction intersecting the one direction is the same over the entire length of upper core 3a extending in the one direction. E-type lower core 3b extends in the other direction, and the sectional shape as a second sectional shape along the one direction is the same over the entire length of lower core 3b extending in the other direction. The same shape is not intended to be geometrically (mathematically) the same, and for example, includes manufacturing errors and the like.

With such a shape, each of upper core 3a and lower core can be manufactured by compression molding in which the material is compressed along one direction. In addition, production by extrusion molding in which the material is extruded along one direction can be performed.

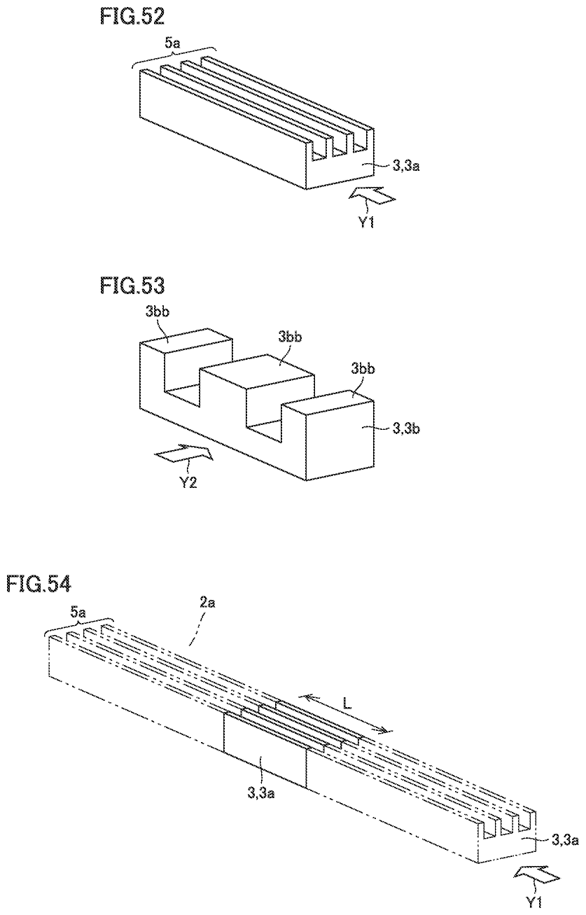

A production method by the compression molding will be described. First, the molding die (not illustrated) molding the upper core and the molding die (not illustrated) molding the lower core are filled with the granular material. Subsequently, as illustrated in FIG. 52, upper core 3a is molded by compressing the granular material, which is filled in the molding die and becomes the upper core, in the direction indicated by an arrow Y1. As illustrated in FIG. 53, lower core 3b is molded by compressing the granular material, which is filled in the mold and becomes the lower core, in the direction indicated by an arrow Y2. Then, upper core 3a and lower core 3b formed are burned to complete upper core 3a and lower core 3b.

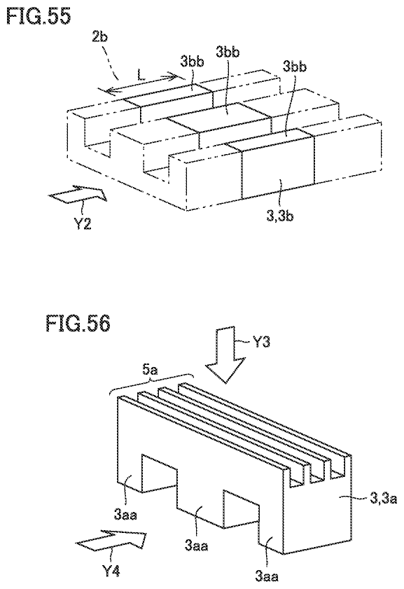

A production method by the extrusion molding will be described below. First, a granular material is filled in an extrusion die (not illustrated) molding a molded body that becomes an upper core. In addition, the granular material is filled in an extrusion die (not illustrated) molding a molded body that becomes a lower core. Subsequently, the molded body is extruded from each extrusion die while applying pressure (arrow Y1: see FIG. 54, arrow Y2: see FIG. 55).

Thus, as illustrated in FIG. 54, an I-type molded body 2a that becomes upper core 3a having the same sectional shape in the direction intersecting the extrusion direction over the entire length is formed. As illustrated in FIG. 55, an E-type molded body 2b that becomes lower core 3b having the same sectional shape in the direction intersecting the extrusion direction over the entire length is formed.

Subsequently, as illustrated in FIG. 54, I-type molded body 2a is cut into a desired length L to form upper core 3a. As illustrated in FIG. 55, lower core 3b is formed by cutting E-type molded body 2b to desired length L. Then, upper core 3a and lower core 3b cut to desired length L are burned to complete upper core 3a and lower core 3b.

In the manufacturing method by the compression molding, upper core 3a and lower core 3b can be formed by compressing the material filled in the molding die in one direction, productivity is improved, and the production cost of core 3 can be reduced.

In the production method by the extrusion molding, the molded body that becomes a plurality of upper cores can be continuously formed by extruding the material filled in an extrusion die in one direction. In addition, the molded body that becomes a plurality of lower cores can be continuously formed. Thus, the productivity can be greatly improved.

The production method by the extrusion molding can also be applied to the upper core or the lower core having different specifications by changing the cutting length of the molded body. Thus, the extrusion die can be shared, and investment for production equipment can also be suppressed.

Furthermore, by applying the production method by the compression molding or the production method by the extrusion molding, upper core 3a and lower core 3b having high shape accuracy can be relatively easily produced without requiring a skilled technique. As a result, the quality of core 3 can be maintained uniformly and stably without increasing the cost.

The ease of removal (draft angle) of fin 5a required in the production method by the compression molding or the production method by the extrusion molding is as described with reference to FIG. 6. In addition, core 3 described in the first embodiment and the like can be easily manufactured by the compression from two directions.

For example, in the case of manufacturing upper core 3a in FIG. 3, upper core 3a can be manufactured by being compressed in the direction indicated by an arrow Y3 and the direction indicated by an arrow Y4 as illustrated in FIG. 56. The direction indicated by arrow Y3 is a direction intersecting the direction in which fin 5a extends, and is a direction in which fin 5a are compression-molded. The direction indicated by arrow Y4 is a direction in which upper core 3a having leg 3aa extends.

### Application Example of Power Conversion Device

An example of a power electronics device to which the power conversion device of the first example or the second example in the seventh embodiment is applied will be described.

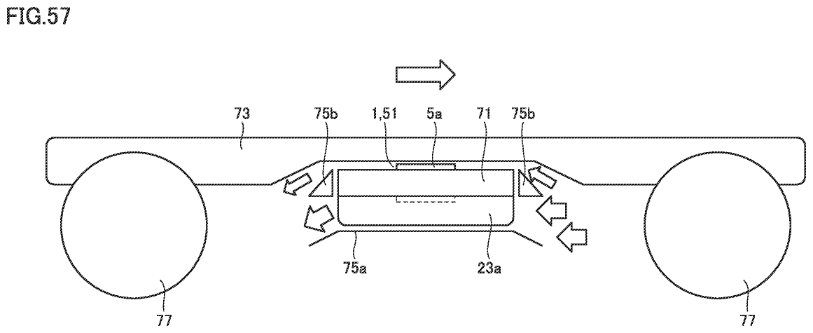

As illustrated in FIG. 57, a power electronic device 71 on which power conversion device 51 is mounted is attached to a traveling device 73 having wheels 77. Fins 5a, 5b (see FIGS. 47 to 50) and air cooling fin 23a of core 3 of power conversion device 51 are exposed. Wind path guides 75a, 75b are disposed around power electronic device 71. When traveling device 73 travels (see a rightward arrow), air (see leftward arrows) is guided to fins 5a, 5b and air cooling fin 23a by wind path guides 75a, 75b.

In traveling device 73 to which power electronics device 71 is attached, the sectional area of the region where power electronics device 71 is disposed between wind path guide 75a and traveling device 73 is smaller than the sectional areas on an inlet side and an outlet side of wind path guide 75a.

For this reason, the speed of the air flowing through the region where power electronics device 71 is disposed is higher than the speed of the air flowing through the respective regions on the inlet side and the outlet side of wind path guide 75a. Thus, the region where power electronics device 71 is disposed has negative pressure, air is easily sucked, and power conversion device 51 is effectively cooled.

An attachment mode in which entire power electronics device 71 is exposed without providing wind path guide 75a or the like is also enabled as a mode in which power electronics device 71 is attached to traveling device 73. However, in this case, a labyrinth structure (not illustrated) that protects power electronic device 71 from dust or sand wound up during traveling, rainwater, and the like is desirably adopted, but the cost is increased. From the viewpoint of cost reduction, desirably wind path guide 75a and the like are provided to send air by negative pressure.

In addition, as an arrangement structure of wind path guide 75a and the like, desirably the shape of the suction port and the shape of the discharge port are the same so as to obtain the same cooling effect with respect to the bidirectional movement of traveling device 73.

The power conversion devices to which the cooling structures described in the embodiments are applied can be variously combined as necessary.

The embodiment disclosed herein is an example and is not limited thereto. The present disclosure is indicated by not the scope described above, but the claims, and it is intended that all modifications within the meaning and scope equivalent to the claims are included.

### INDUSTRIAL APPLICABILITY

The present invention is effectively used for the power conversion device to which the core as the magnetic circuit component is applied.

### REFERENCE SIGNS LIST

1: core cooling structure, 2a, 2b: molded body, 3: core, 3a: upper core, 3aa: leg, 5a: fin, 7a: anticorrosion treatment unit, 3b: lower core, 3bb: leg, 5b: fin, 7b: anticorrosion treatment unit, 11: housing, 13: recess, 15: opening, 17: stepped unit, 19: TIM, 20: buffer material, 21: cooling passage, 23: air cooling fin, 27: sealing material, 29: filler, 11a: lower housing, 11b: upper housing, 13a: recess, 15a: opening, 19a: TIM, 21a: cooling passage, 23a: air cooling fin, 25a: water cooling fin, 26a: cooling passage, 27a: sealing material, 29a: filler, 13b: recess, 15b: opening, 19b: TIM, 21b: cooling passage, 23b: air cooling fin, 25b: water cooling fin, 26b: cooling passage, 27b: sealing material, 29b: filler, 31: printed circuit board, 31a: through-hole, 33: wiring pattern, 33a: wiring pattern, 33b: wiring pattern, 41: strut, 51: power conversion device, 53: switching element, 55: diode, 57: transformer, 61: water cooling device, 63: cooler, 65: compressor, 66: heat dissipation unit, 67: decompression unit, 69: recovery unit, 71: power electronic device, 73: traveling device, 75: wind path guide, 77: wheel, Y1, Y2, Y3, Y4: arrow

1.-20. (canceled)

21. A core cooling structure applied to a core as a component of a magnetic circuit, the core cooling structure comprising:
the core including a first core unit and a second core unit, the core having a magnetic path formed by the first core unit and the second core unit that are disposed to face each other; and
a housing to which the core is attached, wherein
at least one first heat dissipation fin extending in one direction along the magnetic path is formed in the first core unit,
the second core unit is attached so as to be fitted in the housing,
a second heat dissipation fin is disposed in the second core unit,
an opening penetrating the housing from one side to another side is formed in the housing, and
the second core unit is disposed in the opening opened to the one side in the housing, and the second heat dissipation fin is exposed from the opening opened to the other side.

22. The core cooling structure according to claim 21, wherein the housing includes a heat dissipation unit that dissipates heat.

23. The core cooling structure according to claim 22, wherein a cooling passage is formed in the housing.

24. The core cooling structure according to claim 22, wherein the heat dissipation unit includes an air cooling fin.

25. The core cooling structure according to claim 21, wherein an anticorrosion treatment unit is formed on a surface of the second core unit.

26. The core cooling structure according to claim 21, wherein a thermal interface material is interposed between the core and the housing.

27. A power conversion device comprising:
the core cooling structure according to claim 21;
a printed circuit board on which the core is mounted; and
a switching element and a diode element that are disposed between the printed circuit board and the housing, wherein
the first core unit and the second core unit of the core are disposed so as to face each other with the printed circuit board sandwiched therebetween through a through-hole made in the printed circuit board,
the first core unit is disposed on a side of one main surface of the printed circuit board, and
the housing and the second core unit are disposed on a side of another main surface of the printed circuit board.

28. The power conversion device according to claim 27, wherein the second core unit is attached so as to be fitted in the housing.

29. A core cooling structure applied to a core as a component of a magnetic circuit, the core cooling structure comprising:
the core including a first core unit and a second core unit, the core having a magnetic path formed by the first core unit and the second core unit that are disposed to face each other; and
a housing to which the core is attached, wherein
at least one first heat dissipation fin extending in one direction along the magnetic path is formed in the first core unit,
the second core unit is attached so as to be fitted in the housing,
a second heat dissipation fin is disposed in the second core unit,
a cooling passage through which a cooling fluid flows is formed between the second core unit and the housing, and
the cooling passage is formed to cause the second core unit to be cooled directly by the cooling fluid flowing through the cooling passage.

30. The core cooling structure according to claim 29, wherein the housing includes a heat dissipation unit that dissipates heat.

31. The core cooling structure according to claim 29, wherein an anticorrosion treatment unit is formed on a surface of the second core unit.

32. The core cooling structure according to claim 29, wherein
the housing includes:
a housing first unit to which the second core unit is attached; and
a housing second unit to which the first core unit is attached,
the housing first unit and the housing second unit are disposed so as to face each other with the core sandwiched therebetween,
another cooling passage through which a cooling fluid flows is formed between the first core unit and the housing second unit, and
the other cooling passage is formed to cause the first core unit to be cooled directly by the cooling fluid flowing through the other cooling passage.

33. The core cooling structure according to claim 29, wherein a thermal interface material is interposed between the core and the housing.

34. A power conversion device comprising:
the core cooling structure according to claim 29;
a printed circuit board on which the core is mounted; and
a switching element and a diode element that are disposed between the printed circuit board and the housing, wherein
the first core unit and the second core unit of the core are disposed so as to face each other with the printed circuit board sandwiched therebetween through a through-hole made in the printed circuit board,
the first core unit is disposed on a side of one main surface of the printed circuit board, and
the housing and the second core unit are disposed on a side of another main surface of the printed circuit board.

35. A core cooling structure applied to a core as a component of a magnetic circuit, the core cooling structure comprising:
the core including a first core unit and a second core unit, the core having a magnetic path formed by the first core unit and the second core unit that are disposed to face each other; and
a housing to which the core is attached, wherein
at least one first heat dissipation fin extending in one direction along the magnetic path is formed in the first core unit,
the second core unit is attached so as to be fitted in the housing,
the housing includes:
a housing first unit to which the second core unit is attached; and
a housing second unit to which the first core unit is attached,
the housing first unit and the housing second unit are disposed so as to face each other with the core sandwiched therebetween,
the second core unit includes a second heat dissipation fin that extends along the magnetic path and is disposed at intervals in a direction intersecting the magnetic path,
a first opening penetrating the housing first unit from a side on which the core is disposed toward a side opposite to the side on which the core is disposed is formed in the housing first unit, and
the second heat dissipation fin is exposed from the first opening.

36. The core cooling structure according to claim 35, wherein
the housing first unit includes a heat dissipation unit that dissipates heat, and
the heat dissipation unit includes an air cooling fin.

37. The core cooling structure according to claim 35, wherein
a second opening penetrating the housing second unit from the side on which the core is disposed toward the side opposite to the side on which the core is disposed is formed in the housing second unit, and
the first heat dissipation fin is exposed from the second opening.

38. The core cooling structure according to claim 35, wherein an anticorrosion treatment unit is formed on a surface of each of the first core unit and the second core unit.

39. The core cooling structure according to claim 35, wherein a thermal interface material is interposed between the core and the housing.

40. A power conversion device comprising:
the core cooling structure according to claim 35;
a printed circuit board on which the core is mounted; and
a switching element and a diode element that are disposed between the printed circuit board and the housing, wherein
the first core unit and the second core unit of the core are disposed so as to face each other with the printed circuit board sandwiched therebetween through a through-hole made in the printed circuit board,
the first core unit is disposed on a side of one main surface of the printed circuit board, and
the housing and the second core unit are disposed on a side of another main surface of the printed circuit board.
